(19) United States
(12) Patent Application Publication
(10) Pub. No.: US 2025/0360948 A1
(43) Pub. Date: Nov. 27, 2025

(54) VEHICLE CONTROL DEVICE, STORAGE MEDIUM STORING VEHICLE CONTROL PROGRAM, AND VEHICLE CONTROL METHOD

(71) Applicants: DENSO CORPORATION, Kariya-city (JP); J-QuAD DYNAMICS Inc., Tokyo (JP)

(72) Inventors: Kazuki IZUMI, Kariya-city (JP); Yuuki OZAWA, Tokyo (JP); Ryu KAMBARA, Tokyo (JP); Koji SHIBATA, Tokyo (JP); Yuka SATRE, Tokyo (JP); Yuki YAMAMOTO, Tokyo (JP)

(21) Appl. No.: 19/295,023

(22) Filed: Aug. 8, 2025

Related U.S. Application Data
(63) Continuation of application No. PCT/JP2024/005297, filed on Feb. 15, 2024.

(30) Foreign Application Priority Data
Feb. 17, 2023 (JP) 2023-022997

(51) Int. Cl. B60W 60/00; B60W 30/14; B60W 30/165; B60W 30/18; B60W 30/182; B60W 50/14

(52) U.S. Cl. CPC B60W 60/0059; B60W 30/146; B60W 30/165; B60W 30/18018; B60W 30/18159; B60W 30/182; B60W 50/14; B60W 60/0053; B60W 2050/146; B60W 2520/06; B60W 2554/4029; B60W 2555/60

(57) ABSTRACT

A vehicle control device is configured to execute autonomous driving control of a subject vehicle. The vehicle control device is configured to identify a situation of the subject vehicle; and make a determination related to driving. The vehicle control device identifies a situation in which the subject vehicle passes through a plurality of consecutive intersections when the subject vehicle is caused to travel along a scheduled route. The vehicle control device sets a mode to be set in driving control differently according to a driving control difficulty level for passing through the plurality of consecutive intersections. The driving control difficulty level is a driving control difficulty level according to a direction of travel.

### CROSS REFERENCE TO RELATED APPLICATIONS

The present application is a continuation application of International Patent Application No. PCT/JP2024/005297 filed on Feb. 15, 2024 which designated the U.S. and claims the benefit of priority from Japanese Patent Application No. 2023-022997 filed on Feb. 17, 2023. The entire disclosures of all of the above applications are incorporated herein by reference.

### TECHNICAL FIELD

The disclosure according to this specification relates to a technique for autonomously controlling driving of a vehicle.

### BACKGROUND

A technique for autonomously controlling driving of a vehicle is known. In the technique disclosed in a related art, it is determined whether the subject vehicle is traveling at an intersection, and a threshold value for switching the autonomous driving control to the manual driving is calculated according to the determination.

### SUMMARY

According to an aspect of the present disclosure, a vehicle control device configured to execute autonomous driving control of a subject vehicle, the vehicle control device includes at least one of (i) a circuit and (ii) a processor with a memory storing computer program code executable by the processor, the at least one of the circuit and the processor configured to cause the vehicle control device to identify a situation of the subject vehicle, and make a determination related to driving. The vehicle control device may identify a situation in which the subject vehicle passes through a plurality of consecutive intersections when the subject vehicle is caused to travel along a scheduled route. The vehicle control device may set a mode to be set in driving control differently according to a driving control difficulty level for passing through the plurality of consecutive intersections. The driving control difficulty level is a driving control difficulty level according to a direction of travel.

### BRIEF DESCRIPTION OF DRAWINGS

Objects, features and advantages of the present disclosure will become more apparent from the following detailed description made with reference to the accompanying drawings. In the drawings:

FIG. 1 is a view illustrating an overall image of a vehicle system;

FIG. 2 is a diagram for describing details of an automated driving ECU;

FIG. 3 is a diagram illustrating an example of a plurality of consecutive intersections;

FIG. 4 is a flowchart illustrating a processing method by the automated driving ECU;

FIG. 5 is a flowchart illustrating a processing method by the automated driving ECU;

FIG. 6 is a flowchart illustrating a processing method by the automated driving ECU;

FIG. 7 is a flowchart illustrating a processing method by the automated driving ECU;

FIG. 8 is a flowchart illustrating a processing method by the automated driving ECU;

FIG. 9 is a flowchart illustrating a processing method by the automated driving ECU;

FIG. 10 is a flowchart illustrating a processing method by the automated driving ECU;

FIG. 11 is a flowchart illustrating a processing method by the automated driving ECU;

FIG. 12 is a flowchart illustrating a processing method by the automated driving ECU;

FIG. 13 is a diagram illustrating an example of a situation where entry to a dedicated lane is impossible;

FIG. 14 is a flowchart illustrating a processing method by the automated driving ECU;

FIG. 15 is a diagram for describing a position where a driving-mode switch is easy;

FIG. 16 is a flowchart illustrating a processing method by the automated driving ECU;

FIG. 17 is a view for describing a section line;

FIG. 18 is a flowchart illustrating a processing method by the automated driving ECU;

FIG. 19 is a diagram illustrating an example of a plurality of consecutive intersections;

FIG. 20 is a flowchart illustrating a processing method by the automated driving ECU;

FIG. 21 is a flowchart illustrating a processing method by the automated driving ECU;

FIG. 22 is a flowchart illustrating a processing method by the automated driving ECU;

FIG. 23 is a diagram illustrating an example of a plurality of consecutive intersections;

FIG. 24 is a flowchart illustrating a processing method by the automated driving ECU;

FIG. 25 is a flowchart illustrating a processing method by the automated driving ECU;

FIG. 26 is a flowchart illustrating a processing method by the automated driving ECU;

FIG. 27 is a flowchart illustrating a processing method by the automated driving ECU;

FIG. 28 is a flowchart illustrating a processing method by the automated driving ECU;

FIG. 29 is a flowchart illustrating a processing method by the automated driving ECU;

FIG. 30 is a diagram illustrating an example of a plurality of consecutive intersections;

FIG. 31 is a flowchart illustrating a processing method by the automated driving ECU;

FIG. 32 is a flowchart illustrating a processing method by the automated driving ECU; and

FIG. 33 is a flowchart illustrating a processing method by the automated driving ECU.

### DETAILED DESCRIPTION

On an actual road, there is a case where the subject vehicle is required to pass through a place where a plurality of intersections is continuous at short intervals during the autonomous driving control. However, in the technique of Patent Literature 1, it is difficult to optimize control when passing through consecutive intersections. Therefore, there is room for improvement in terms of convenience for the occupant.

The present disclosure provides a vehicle control device, a vehicle control program, and a vehicle control method of enhancing convenience of an occupant.

According to one aspect of the present disclosure, a vehicle control device configured to execute autonomous driving control of a subject vehicle comprises: a situation identification section configured to identify a situation of the subject vehicle; and a determination section configured to make a determination related to driving. The situation identification section identifies a situation in which the subject vehicle passes through a plurality of consecutive intersections when the subject vehicle is caused to travel along a scheduled route. The determination section sets a mode to be set in driving control differently according to a driving control difficulty level for passing through the plurality of consecutive intersections. The driving control difficulty level is a driving control difficulty level according to a direction of travel.

According to the aspect, in a situation where the subject vehicle passes through a plurality of consecutive intersections, the mode of the driving control is set to be different according to the driving control difficulty level of these intersections. Therefore, the subject vehicle can pass through a plurality of consecutive intersections according to the mode optimized according to the driving control difficulty level. Therefore, the occupant who uses the autonomous driving control can enjoy high convenience.

Hereinafter, a plurality of embodiments will be described with reference to the drawings. The same reference numerals are given to corresponding components in each embodiment, and redundant description may be omitted. In a case where only part of the configuration is described in each embodiment, the configuration of the other embodiments described above can be applied to other parts of the configuration. In addition, not only a combination of configurations explicitly described in the description of each embodiment but also configurations of a plurality of embodiments can be partially combined even if not explicitly described as long as there is no problem in the combination.

### First Embodiment

A vehicle system 1 can be used, for example, in a vehicle at the automation level 2 to 5 capable of executing autonomous control of driving (hereinafter, autonomous driving control). The vehicle system 1 is mounted on a subject vehicle Am as a vehicle. The automation level is an index indicating a stage of automated driving of the automated driving vehicle, and there may be a plurality of levels, for example, as defined in SAE. The automation level is divided into levels 0 to 5 as follows, for example.

Level 0 is a level at which the driver performs all driving tasks without system intervention. The driving task may be referred to as a dynamic driving task. The driving tasks are, for example, steering, acceleration/deceleration, and surroundings monitoring. Level 0 corresponds to so-called full manual driving. Level 1 is a level at which the system supports either steering or acceleration/deceleration. Level 1 corresponds to so-called driving assistance. Level 2 is a level at which the system supports both steering and acceleration/deceleration. Level 2 corresponds to partial driving automation. For example, in Levels 1 to 2, the driver has the monitoring obligation (hereinafter, monitoring obligation) related to safe driving. That is, levels 1 to 2 may be classified as manual driving in a broad sense. The monitoring obligation includes visual surroundings monitoring.

Level 3 is a level at which the system is capable of performing all driving tasks under certain conditions and at which a driver performs a driving operation in an emergency. In the automated driving at Level 3, in a case where there is a driving-mode switch request from the system, it is required that the driver can respond quickly. This driving-mode switch can be referred to as transfer of the surroundings monitoring obligation from the vehicle system to the driver. Level 3 corresponds to so-called conditional driving automation. Level 3 includes an area-limited level 3 limited to a specific area. The specific area referred to herein may be an expressway. The specific area may be, for example, a specific lane. Level 3 includes a congestion limited level 3 limited to congestion. The automated driving at the congestion limited level 3 corresponds to the congestion limited automated driving. The congestion limited level 3 may be configured to be limited to, for example, congestion on an expressway. The expressway may include an automobile exclusive road.

Level 4 is a level at which the system can perform all driving tasks except under specific situations such as unsupportable roads and extreme environments. Level 4 corresponds to so-called advanced driving automation. The automated driving at Level 5 is a level at which the system can perform all driving tasks under any environment. Level 5 corresponds to so-called full driving automation. The automated driving at Levels 4 and 5 may be performed, for example, in a travel section in which highly accurate map data is prepared. The highly accurate map data will be described later.

For example, Levels 4 to 5 may be classified as automated driving. The automated driving at Levels 3 to 5 can be said to be automated driving in which the driver has no monitoring obligation. During automated driving at Level 3 to 5, a second task may be permitted. The second task is an action other than driving permitted to the driver, and is a specific action defined in advance. The second task can be rephrased as work other than the driving task. The second task can be referred to as a secondary activity, another activity, or the like. The second task should not prevent the driver from responding to the driving operation takeover request (hereinafter, the driving-mode switch request) from the system. As an example, actions such as viewing content such as a moving image, operating a smartphone or the like, reading, and eating are assumed as the second task.

Among the automated driving of Levels 3 to 5, the automated driving of Level 4 or higher corresponds to the automated driving in which the driver is permitted to sleep. That is, it corresponds to sleep permission automated driving. The automated driving at Level 4 or higher can be referred to as automated driving that does not require a driving-mode switch to the driver even in an emergency. Among the automated driving at Levels 3 to 5, the automated driving at level 3 corresponds to automated driving in which driver is not permitted to sleep (hereinafter, sleep non-permission automated driving). It is assumed that the automated driving vehicle of the present embodiment can switch the automation level. The automation level may be configured to be switchable only between some levels of Levels 0 to 5. The automated driving vehicle of the present embodiment can switch at least between automated driving without monitoring obligation and manual driving.

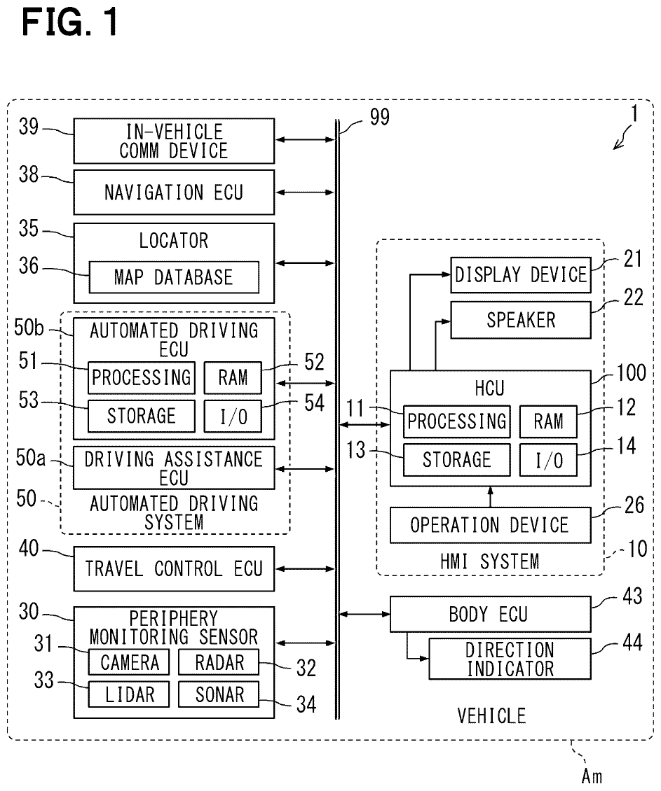

As illustrated in FIG. 1, the vehicle system 1 includes a surroundings monitoring sensor 30, a locator 35, a navigation ECU 38, an in-vehicle communication device 39, a travel control ECU 40, a body ECU 43, a driving assistance ECU 50a, an automated driving ECU 50b, and an HCU 100. The surroundings monitoring sensor 30, the locator 35, the navigation ECU 38, the in-vehicle communication device 39, the travel control ECU 40, the body ECU 43, the driving assistance ECU 50a, the automated driving ECU 50b, and the HCU 100 are communicably connected to a communication bus 99 of an in-vehicle network mounted on the subject vehicle Am. These nodes connected to the communication bus 99 can communicate with each other. Specific nodes among the devices, the ECUs, and the like may be electrically connected to each other directly by a wire harness or the like, and may communicate with each other without via the communication bus 99.

The surroundings monitoring sensor 30 is an autonomous sensor that monitors the surroundings environment of the subject vehicle Am. The surroundings monitoring sensor 30 includes, for example, one or more of a camera unit 30a, a millimeter wave radar 30b, a rider 30c, and a sonar 30d. The surroundings monitoring sensor 30 can detect a moving object and a stationary object from a detection range around the subject vehicle. The surroundings monitoring sensor 30 provides detection information of an object around the subject vehicle to the driving assistance ECU 50a, the automated driving ECU 50b, and the like.

The locator 35 includes a global navigation satellite system (GNSS) receiver, an inertial sensor, and the like. The locator 35 combines positioning signals received from a plurality of positioning satellites by the GNSS receiver, measurement results by the inertial sensor, vehicle speed information output to the communication bus 99, and the like to sequentially measure the position, the traveling direction, and the like of the subject vehicle Am. The locator 35 sequentially outputs the position information and the direction information of the subject vehicle Am based on the positioning result to the communication bus 99 as locator information.

The navigation ECU 38 acquires information about a destination designated by the occupant including the driver based on the operation information acquired from the HCU 100. The navigation ECU 38 acquires subject vehicle position information and direction information from the locator 35, and sets a route from the current position to the destination. The navigation ECU 38 provides route information indicating a setting route to a destination to the driving assistance ECU 50a, the automated driving ECU 50b, the HCU 100, and the like. The navigation ECU 38 cooperates with an HMI system 10 to combine a screen display, a voice message, and the like as route guidance to the destination, and notifies the driver of the traveling direction of the subject vehicle Am at the intersections IS1 and IS2, the branch point, and the like.

Here, a user terminal such as a smartphone may be connected to the in-vehicle network or the HCU 100. Such a user terminal may provide subject vehicle position information, direction information, map data, and the like to the driving assistance ECU 50a, the automated driving ECU 50b, and the like instead of the locator 35. Further, instead of the navigation ECU 38, the user terminal may provide route information to the destination to the driving assistance ECU 50a, the automated driving ECU 50b, the HCU 100, and the like.

The in-vehicle communication device 39 is an out-of-vehicle communication unit mounted on the subject vehicle Am, and functions as a vehicle to everything (V2X) communication device. The in-vehicle communication device 39 transmits and receives information to and from a roadside device installed beside a road by wireless communication. As an example, the in-vehicle communication device 39 receives congestion information, road construction information, and the like around the current position and in the traveling direction of the subject vehicle Am from a roadside device. The congestion information and the road construction information are VICS (registered trademark) information and the like. The in-vehicle communication device 39 may further receive traffic signal information about display of traffic signals TS1 and TS2 at the intersection from a roadside device. The in-vehicle communication device 39 provides the received congestion information, road construction information, and traffic signal information to the automated driving ECU 50b, the HCU 100, and the like.

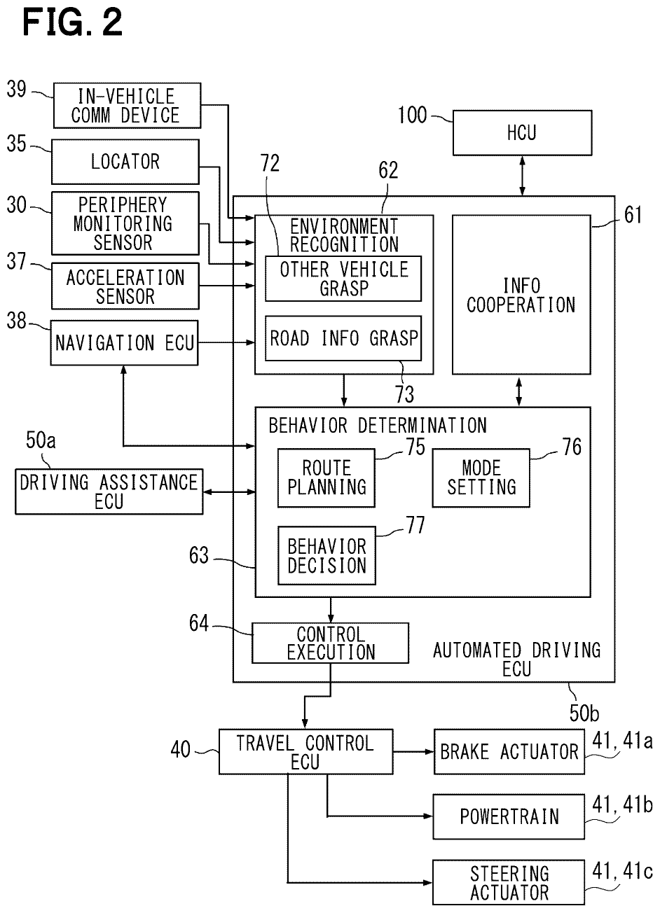

The travel control ECU 40 is an electronic control device mainly including a microcontroller. The travel control ECU 40 has at least functions of a brake control ECU, a drive control ECU, and a steering control ECU. The travel control ECU 40 operates a driving actuator 41 based on any one of an operation command based on the driving operation by the driver, a control command of the driving assistance ECU 50a, and a control command of the automated driving ECU 50b. As illustrated in FIG. 2, the driving actuator 41 includes a brake actuator 41a for controlling braking force of each wheel, a power train 41b for controlling acceleration of the vehicle, and a steering actuator 41c for controlling steering.

The body ECU 43 is an electronic control device mainly including a microcontroller. The body ECU 43 has a function of controlling operation of a lighting device mounted on the subject vehicle Am. The lighting device is, for example, a direction indicator 44 or a hazard lamp. The body ECU 43 starts blinking of one of left and right direction indicators 44 corresponding to an operation direction based on detection of a user operation input to a direction indication switch (indicator lever) provided in a steering column section or the like. During the autonomous driving control, the body ECU 43 can blink the direction indicator 44 according to restart from the state of being evacuated to the road side, a lane change, a right or left turn at the intersection, and the like based on a control command from the automated driving ECU 50b.

As illustrated in FIG. 1, the HCU 100 is electrically connected to notification devices such as a display device 21 and a speaker 22, and an operation device 26. The HCU 100, the display device 21, the speaker 22, and the operation device 26 constitute the HMI system 10 of the subject vehicle Am. A plurality of display devices 21, a plurality of speakers 22, and a plurality of operation devices 26 may be provided.

The display device 21 makes a notification of information through vision of the driver or another occupant by image display or the like. The display device 21 may include a meter display, a center information display (CID), a head-up display (hereinafter, HUD), and the like. The CID has a touch panel function, and detects a touch operation on a display screen by a driver or another occupant. That is, the CID corresponds to the operation device 26. The HUD is visually recognizable from the vehicle interior of the subject vehicle Am, and can display a virtual image floating outside the subject vehicle Am. The speaker 22 is installed in the vehicle interior and reproduces a notification sound, a voice message, or the like in the vehicle interior.

The operation device 26 is an input section that receives a user operation by a driver or another occupant. For example, a user operation related to the operation and stop of the automated driving function, a user operation related to the setting of the destination of the route guidance, and the like are input to the operation device 26. The operation device 26 includes the direction indication switch described above, the hazard switch for turning on the hazard lamp, and the CID. In addition, the operation device 26 includes a steering switch provided on a spoke portion of the steering operation section, a voice input device that recognizes utterance content of a driver or another occupant, and the like.

The HCU 100 is an information presentation device that integrally controls a notification using the plurality of display devices 21 and the speaker 22. The HCU 100 controls a notification of information about automated driving in cooperation with an automated driving system 50. The HCU 100 is a computer mainly including a control circuit including a processing section 11, a RAM 12, a storage section 13, an input/output interface 14, a bus connecting these, and the like. The processing section 11 executes various processes for the notification control process by accessing the RAM 12. The RAM 12 may include a video RAM for generating video data. The storage section 13 stores various programs to be executed by the processing section 11.

The processing section 11 may include at least one processor. The processor includes, as a core, at least one of, for example, a central processing unit (CPU), a graphics processing unit (GPU), a reduced instruction set computer (RISC)-CPU, and the like. The storage section 13 may include at least one type of non-transitory tangible storage medium among, for example, a semiconductor memory, a magnetic medium, an optical medium, and the like that non-transiently stores programs, data, and the like readable by the processor.

The driving assistance ECU 50a and the automated driving ECU 50b constitute the automated driving system 50 of the subject vehicle Am. The driving assistance ECU 50a implements a driving assistance function of assisting the driving operation by the driver in the automated driving system 50. The driving assistance ECU 50a enables driving assistance of about Level 2 or partial automated driving.

The automated driving ECU 50b is capable of substituting for the driving operation by the driver, and is capable of performing automated driving of Level 3 or higher in which the system is a control subject. The automated driving performed by the automated driving ECU 50b is the automated driving of eyes-off in which the driver is not obliged to monitor the surroundings, that is, the driver is not obliged to monitor the surroundings.

The driving assistance ECU 50a is a computer mainly including a control circuit including a processing section, a random access memory (RAM), a storage section, an input/output interface, a bus connecting these, and the like. The driving assistance ECU 50a implements driving assistance functions such as adaptive cruise control (ACC), lane trace control (LTC), and lane change assist (LCA) by executing a program in the processing section. The ACC, the LTC, and the LCA are referred to as applications for driving assistance. The driving assistance ECU 50a provides control status information indicating a state of driving assistance control to the automated driving ECU 50b.

The processing section may include at least one processor. The processor includes, as a core, at least one of, for example, a central processing unit (CPU), a graphics processing unit (GPU), a reduced instruction set computer (RISC)-CPU, and the like. The storage section may include at least one type of non-transitory tangible storage medium among, for example, a semiconductor memory, a magnetic medium, an optical medium, and the like that non-transiently stores programs, data, and the like readable by the processor.

The automated driving ECU 50b has higher calculation capability than the driving assistance ECU 50a, and can perform at least travel control corresponding to ACC and LTC. The automated driving ECU 50b may be capable of performing driving assistance control in which the driver is obliged to monitor the surroundings instead of the driving assistance ECU 50a in a scene where the control by the driving assistance ECU 50a is temporarily interrupted.

The automated driving ECU 50b is a computer mainly including a control circuit including a processing section 51, a RAM 52, a storage section 53, an input/output interface 54, a bus connecting these, and the like. The processing section 51 executes various processes for realizing the automated driving control method of the present disclosure by accessing the RAM 52. The storage section 53 stores various programs to be executed by the processing section 51. The program includes a vehicle control program for autonomous driving control of the subject vehicle Am.

The processing section 51 may include at least one processor. The processor includes, as a core, at least one of, for example, a central processing unit (CPU), a graphics processing unit (GPU), a reduced instruction set computer (RISC)-CPU, and the like. The storage section 53 may include at least one type of non-transitory tangible storage medium among, for example, a semiconductor memory, a magnetic medium, an optical medium, and the like that non-transiently stores programs, data, and the like readable by the processor.

By execution of the program by the processing section 51, in the automated driving ECU 50b, an information linkage section 61, an environment recognition section 62, an action determination section 63, a control execution section 64, and the like are constructed as a plurality of function sections for realizing the automated driving function (see FIG. 2).

The information linkage section 61 provides information to the HCU 100 and acquires information from the HCU 100. Through the cooperation, the automated driving ECU 50b and the HCU 100 share the information acquired by each. The information linkage section 61 generates control status information indicating an operation state of the automated driving function, and provides the generated control status information to the HCU 100.

The information linkage section 61 enables a notification by the HCU 100 synchronized with the operation state of the automated driving function by outputting control status information to the HCU 100. In addition, the information linkage section 61 acquires operation information or the like of the driver or another occupant from the HCU 100, and grasps the content of the user operation input to the HMI system 10 or the like.

The environment recognition section 62 recognizes environment information around the subject vehicle Am. The environment information may be recognized as being acquired from the in-vehicle communication device 39, the locator 35, the surroundings monitoring sensor 30, and the like. The environment information may be recognized by fusing information acquired by the in-vehicle communication device 39, the locator 35, the surroundings monitoring sensor 30, and the like.

The environment recognition section 62 includes an another vehicle grasping section 72 and a road information grasping section 73 as sub-function sections for travel environment recognition. The another vehicle grasping section 72 grasps a relative position, a relative speed, and the like of a dynamic target around the subject vehicle, such as another vehicle traveling around the subject vehicle Am. The another vehicle grasping section 72 grasps at least a preceding vehicle and a following vehicle traveling in the same lane (hereinafter, a subject lane) as the subject vehicle Am, and a side vehicle traveling in an adjacent lane adjacent to the subject lane. In a case where the subject vehicle Am travels on a road with three or more lanes, the another vehicle grasping section 72 grasps a side vehicle traveling in a lane located opposite the subject lane with the adjacent lane interposed therebetween.

The road information grasping section 73 grasps information about a road on which the subject vehicle Am travels. In a case of acquiring the route information from the navigation ECU 38, the road information grasping section 73 extracts the specific points of the road on which the subject vehicle Am is traveling and the road on which the subject vehicle Am is scheduled to travel, the intersections IS1 and IS2, the branch points (junctions and the like) of the expressway, the merging points, the exit points, and the like. Further, the road information grasping section 73 grasps, for the road on which the subject vehicle Am is scheduled to travel, a congestion section in which congestion has occurred, a restriction section in which restriction has occurred due to road construction or the like, and the like.

The environment recognition section 62 aggregates the information of the another vehicle grasping section 72 and the road information grasping section 73, and identifies the situation of the subject vehicle Am. Specifically, the environment recognition section 62 identifies a situation (hereinafter, referred to as a consecutive intersections scheduled situation) in which the subject vehicle Am passes through a plurality of consecutive intersections IS1 and IS2 when the subject vehicle Am is caused to travel along a scheduled route PT. Here, the scheduled route PT may be a route acquired from the navigation ECU 38 or a route acquired from the action determination section 63.

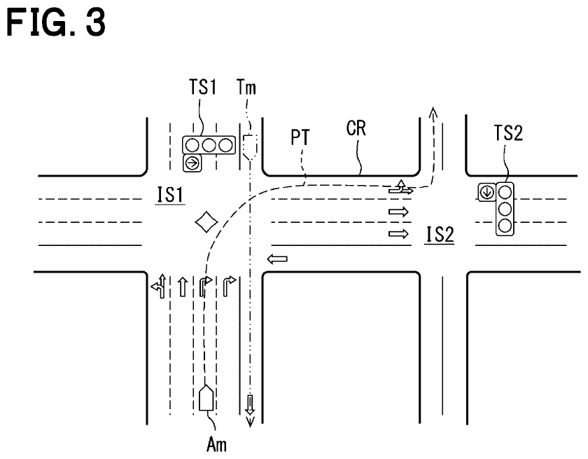

The plurality of consecutive intersections IS1 and IS2 may mean, for example, a plurality of intersections where an interval (for example, the interval between the centers of the intersections IS1 and IS2) between the intersections is about 150 to 300 m as illustrated in FIG. 3. In the present embodiment, the automated driving ECU 50b executes vehicle control corresponding to two consecutive intersections IS1 and IS2.

Here, even when a plurality of consecutive intersections IS1 and IS2 are present on the road, it is assumed that the situation in which the subject vehicle Am passes through only the first intersection IS1 and the subject vehicle Am is scheduled not to enter the second intersection IS2 does not correspond to the consecutive intersections scheduled situation. For example, in FIG. 3, even when the plurality of intersections IS1 and IS2 are disposed continuously, a situation where the subject vehicle Am travels in a direction different from the second intersection IS2 by going straight through the first intersection IS1 does not correspond to the consecutive intersections scheduled situation. On the other hand, a situation in which the subject vehicle Am is scheduled to pass through both of two consecutive intersections IS1 and IS2 corresponds to the consecutive intersections scheduled situation.

The action determination section 63 cooperates with the driving assistance ECU 50a and the HCU 100 to control the driving-mode switch between the automated driving system 50 and the driver. In a case where the automated driving ECU 50b has the control right of the driving operation, the action determination section 63 generates a traveling track TAm on which the subject vehicle Am is scheduled to travel based on the recognition result of the travel environment by the environment recognition section 62 to output the generated traveling track TAm to the control execution section 64. The action determination section 63 includes a route planning section 75, a mode setting section 76, and an action decision section 77 as sub-function sections for controlling the operation state of the automated driving function.

The route planning section 75 plans a route PT on which the subject vehicle Am travels by autonomous driving control. The route PT may be the route itself acquired from the navigation ECU 38. On the other hand, the route planning section 75 may modify or partially change the route to the destination set by the navigation ECU 38 to the route PT suitable for automated driving control. Furthermore, the route planning section 75 may feedback the corrected or partially changed route PT to the navigation ECU 38.

Alternatively, the route planning section 75 may acquire destination information set by the driver from the HCU 100 or the navigation ECU 38 and independently plan the route PT. Furthermore, the route planning section 75 may provide the scheduled route PT to the navigation ECU 38.

The mode setting section 76 comprehensively determines the environment information and the situation recognized by the environment recognition section 62, the route plan by the route planning section 75, and the like, and sets a mode related to driving control. The mode related to the driving control may include a mode related to the switchable automation level described above. For example, the mode setting section 76 switchably sets between a mode in which the autonomous driving control is executed (hereinafter, autonomous driving mode) and a mode in which the driver is caused to execute the manual driving (hereinafter, manual driving mode).

The mode related to the driving control may include a mode related to restriction of the speed, acceleration, and deceleration of the subject vehicle Am. For example, the mode setting section 76 can switchably set between an unrestricted mode, a mode for limiting the speed of the subject vehicle Am (hereinafter, the speed limit mode), a mode for limiting the acceleration of the subject vehicle Am (hereinafter, the acceleration limit mode), and a mode for limiting the deceleration (hereinafter, deceleration limit mode).

The action decision section 77 decides a specific action of the subject vehicle Am in accordance with the route plan by the route planning section 75 and the mode setting by the mode setting section 76. For example, the action decision section 77 decides a specific action of the subject vehicle Am in the autonomous driving control in a case where the mode for executing the autonomous driving control is set. This action includes, for example, actions such as acceleration, deceleration, turn, temporary stop, and lane change. Furthermore, for example, the action decision section 77 starts the control for the driving-mode switch in a case where the mode switching from the autonomous driving control to the manual driving is set. The control for the driving-mode switch includes driving control of the subject vehicle Am until the driving-mode switch is executed, and a decision of a request to the HCU 100 for a notification regarding the driving-mode switch to the driver. The notification regarding the driving-mode switch includes a notification requesting that the driver start manual driving. In a case where the speed limit mode of the subject vehicle Am is set, the action decision section 77 decides a specific action of the subject vehicle Am within a limited speed range.

In a case where the automated driving ECU 50b has the control right of the driving operation, the control execution section 64 executes acceleration/deceleration control, steering control, and the like of the subject vehicle Am in accordance with the action plan generated by the action determination section 63 in cooperation with the travel control ECU 40. Specifically, the control execution section 64 generates a control command for each driving actuator 41 based on the scheduled action plan, and sequentially outputs the generated control command to the travel control ECU 40.

Here, vehicle control in the consecutive intersections scheduled situation will be described in more detail. In a case where the consecutive intersections scheduled situation is identified, the mode setting section 76 is configured to set the mode related to the driving control differently according to the driving control difficulty level in passing through the intersections IS1 and IS2. The driving control difficulty level may be stored in the storage section 53 in a database in association with the traveling directions of the intersections IS1 and IS2. The driving control difficulty level may be calculated each time based on the route plan scheduled by the route planning section 75.

Alternatively, the driving control difficulty level may or may not be clearly defined as a parameter in the program or algorithm. That is, by setting conditional branches for setting the mode based on the traveling directions of the intersections IS1 and IS2 in a program or algorithm, the mode may be configured to be set to be different substantially according to the driving control difficulty level for each traveling direction.

Hereinafter, the relationship between the traveling direction of the intersections IS1 and IS2 and the driving control difficulty level will be described based on an application example to the road traffic law in Japan in which the vehicle travels on the left. In the present embodiment, the driving control difficulty level is set for the traveling direction pattern in which the subject vehicle Am executes a right turn or a left turn at the first intersection IS1 and the second intersection IS2.

In a case of left-hand traffic, a right turn used in the following description corresponds to a turn in which planar intersection with an oncoming straight vehicle Tm occurs. A left turn used in the following description corresponds to a turn in which planar intersection with the oncoming straight vehicle Tm does not occur. Here, the oncoming straight vehicle Tm is assumed to be used for defining the traveling direction of the intersection, and it is not necessary for the oncoming straight vehicle Tm to be actually present at the intersection. The oncoming straight vehicle Tm in this definition is a vehicle that enters the intersections IS1 and IS2 from a road in a direction opposite a direction of the subject vehicle Am among the roads connected to the intersections IS1 and IS2, and can be rephrased as a vehicle (this vehicle may be referred to as a priority vehicle) that can pass through the intersection more preferentially than the subject vehicle Am. Under the application of the road traffic law in which vehicles travel on the right, the relationship between right turn and left turn and occurrence of planar intersection is reversed.

For example, the driving control difficulty level is the lowest in the pattern (1), and is higher in the order of the pattern (2), the pattern (3), and the pattern (4). The pattern (1) is a pattern in which a left turn is made at the first intersection IS1 and a left turn is made at the second intersection IS2 (turning left→turning left). The pattern (2) is a pattern in which a left turn is made at the first intersection IS1 and a right turn is made at the second intersection IS2 (turning left→turning right). The pattern (3) is a pattern in which a right turn is made at the first intersection IS1 and a left turn is made at the second intersection IS2 (turning right→turning left). The pattern (4) is a pattern in which a right turn is made at the first intersection IS1 and a right turn is made at the second intersection IS2 (turning right→turning right).

Here, the mode setting section 76 sets the autonomous driving mode in a case of the patterns (1) and (2). The mode setting section 76 sets the manual driving mode in a case of the patterns (3) and (4).

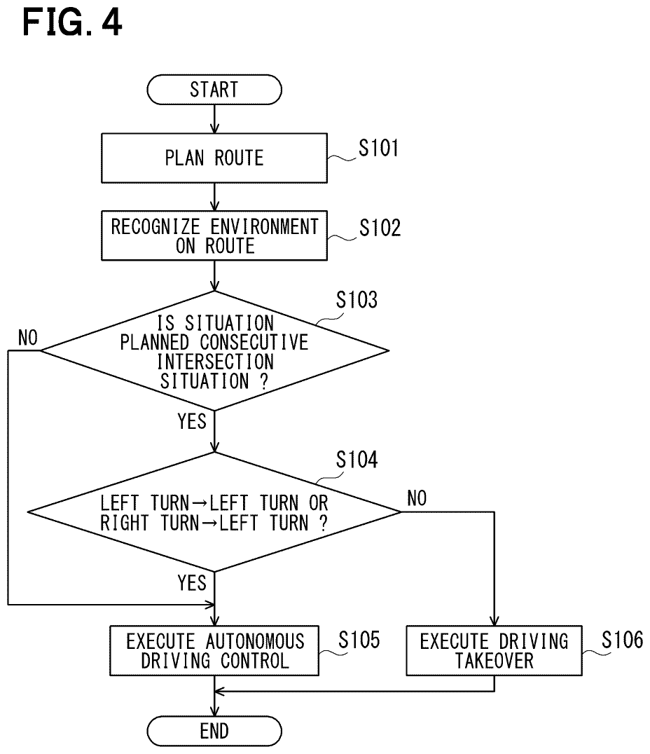

Next, an example of a processing method by the automated driving ECU 50b will be described with reference to a flowchart of FIG. 4. The series of processes shown in steps S101 to 107 is executed in a case where the driving of the subject vehicle Am is autonomously controlled. This series of processes are by at least one processor of the automated driving ECU 50b executing a program.

In S101, the route planning section 75 plans the route PT of the subject vehicle Am. After the process of S101, the process proceeds to S102.

In S102, the environment recognition section 62 recognizes the environment on the planned route PT. The environment recognition here includes identifying that the situation where the subject vehicle Am is located is a consecutive intersections scheduled situation. After the process of S102, the process proceeds to S103.

In S103, the mode setting section 76 determines whether the situation of the subject vehicle Am is the consecutive intersections scheduled situation. In a case of Yes, the process proceeds to S104. In a case of No, the process proceeds to S105.

In S104, the mode setting section 76 determines whether the traveling direction pattern of the subject vehicle Am at the intersections IS1 and IS2 is the pattern (1) or (2). In a case of Yes, the process proceeds to S105. In a case of No, the process proceeds to S106.

In S105, the mode setting section 76 sets the autonomous driving mode. Based on this, the autonomous driving control is continued by the action decision section 77 and the control execution section 64. The series of processes terminates at S105.

In S106, the mode setting section 76 sets the manual driving mode. Based on this, the driving-mode switch to the driver is executed by the action decision section 77 and the control execution section 64. Execution of the driving-mode switch includes a notification of the driving-mode switch and the like. The series of processes terminates at S106.

According to the first embodiment described above, in a situation where the subject vehicle Am passes through a plurality of consecutive intersections IS1 and IS2, the driving control mode is set to be different according to the driving control difficulty level for each traveling direction of these intersections IS1 and IS2. Therefore, the subject vehicle Am can pass through a plurality of consecutive intersections IS1 and IS2 according to the mode optimized according to the driving control difficulty level. Therefore, the occupant who uses the autonomous driving control can enjoy high convenience.

The mode related to the automation level is set differently according to the driving control difficulty level. Therefore, continuation of the autonomous driving control in a situation exceeding the ability of the autonomous driving control is suppressed, so that convenience can be enhanced.

In a case where the mode related to the automation level is switched to the mode for causing the driver to execute the manual driving, the driver is notified of starting of the manual driving. Since the driver can prepare for manual driving based on this notification, the driving-mode switch from the system to the driver can be smoothly performed. Therefore, convenience can be enhanced.

In addition, the subject vehicle Am is scheduled to make a turn in which planar intersection with the oncoming straight vehicle Tm does not occur at the first intersection IS1, and is scheduled to make a turn in which planar intersection with the oncoming straight vehicle Tm does not occur at the second intersection IS2. Alternatively, the subject vehicle Am is scheduled to make a turn in which planar intersection with the oncoming straight vehicle Tm occurs at the first intersection IS1, and is scheduled to make a turn in which planar intersection with the oncoming straight vehicle Tm does not occur at the second intersection IS2. In these traveling direction patterns, a mode for executing autonomous driving control is set.

On the other hand, the subject vehicle Am is scheduled to make a turn in which planar intersection with the oncoming straight vehicle Tm does not occur at the first intersection IS1, and is scheduled to make a turn in which planar intersection with the oncoming straight vehicle Tm occurs at the second intersection IS2. Alternatively, the subject vehicle Am is scheduled to make a turn in which a planar intersection with the oncoming straight vehicle Tm occurs at the first intersection IS1, and is scheduled to make a turn in which a planar intersection with the oncoming straight vehicle Tm occurs at the second intersection IS2. In these traveling direction patterns, a mode for causing the driver to execute manual driving is set.

That is, the autonomous driving control or the manual driving is allocated for each traveling direction, and this is based on the driving control difficulty level. Therefore, continuation of the autonomous driving control in a situation exceeding the ability of the autonomous driving control is suppressed, so that convenience can be enhanced.

In the first embodiment, the automated driving ECU 50b corresponds to a “vehicle control device”. The environment recognition section 62 corresponds to a “situation identification section”. The action determination section 63 corresponds to a “determination section”.

### Second Embodiment

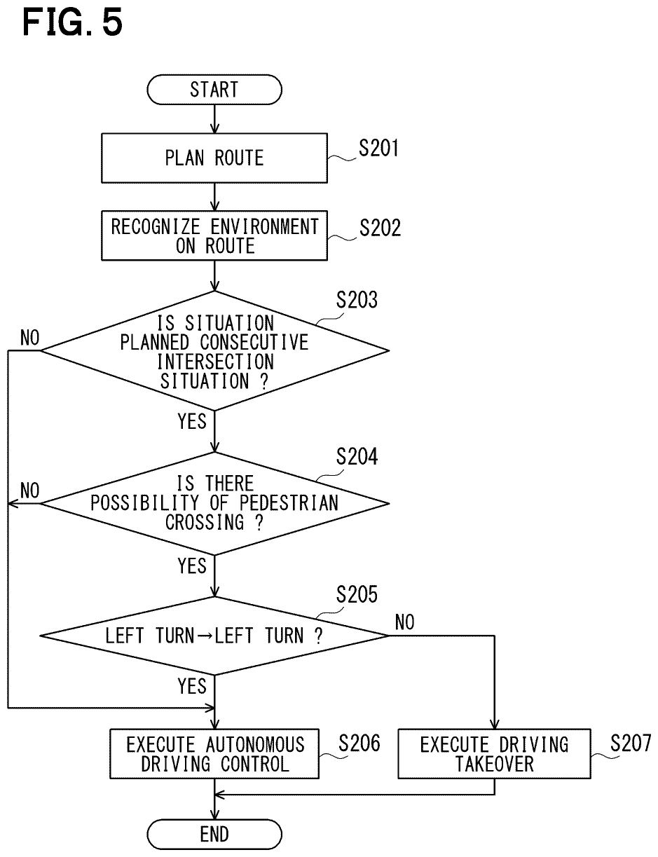

As illustrated in FIG. 5, the second embodiment is a modification of the first embodiment. The second embodiment will be described focusing on differences from the first embodiment.

In the second embodiment, the mode setting section 76 determines whether there is a possibility that a vulnerable road user such as a pedestrian crosses the consecutive intersections passage route PT on which the subject vehicle Am is scheduled to travel. In a case where there is the possibility and in a case of the pattern (1), the mode setting section 76 sets the autonomous driving mode. In a case where there is the possibility and in a case of the patterns (2), (3), and (4) are satisfied, the mode setting section 76 sets the manual driving mode.

Next, an example of a processing method by the automated driving ECU 50b will be described with reference to a flowchart of FIG. 5. S201 to 203 are similar to S101 to 103. In a case of Yes in S203, the process proceeds to S204. In a case of No, the process proceeds to S206.

In S201, the route planning section 75 plans a route of the subject vehicle Am. After the process of S201, in S202 S204, the mode setting section 76 determines whether there is a possibility that a pedestrian crosses the route PT on which the subject vehicle Am is scheduled to travel at the intersections IS1 and IS2. In a case of Yes, the process proceeds to S205. In a case of No, the process proceeds to S206.

In S205, the mode setting section 76 determines whether the traveling direction pattern of the subject vehicle Am at the intersections IS1 and IS2 is the pattern (1). In a case of Yes, the process proceeds to S206. In a case of No, the process proceeds to S207. S206 to 207 are similar to S105 to 106. The series of processes terminates at S206 or S207.

According to the second embodiment described above, the subject vehicle Am is scheduled to make a turn in which planar intersection with the oncoming straight vehicle Tm does not occur at the first intersection IS1, and is scheduled to make a turn in which planar intersection with the oncoming straight vehicle Tm does not occur at the second intersection IS2. In this traveling direction pattern, in a case where there is a possibility that a vulnerable road user crosses the route PT on which the subject vehicle Am is scheduled to travel at two consecutive intersections IS1 and IS2, a mode for causing the driver to execute manual driving is set. On the other hand, in a case where there is no possibility, a mode for executing autonomous driving control is set. In a case where it is predicted that the traffic condition at the plurality of consecutive intersections IS1 and IS2 is more complicated due to the possibility of the vulnerable road user crossing, it is decided in advance that the driver is caused to perform the manual driving, whereby continuation of the autonomous driving control is suppressed in a situation exceeding the ability of the autonomous driving control. That is, convenience can be enhanced.

### Third Embodiment

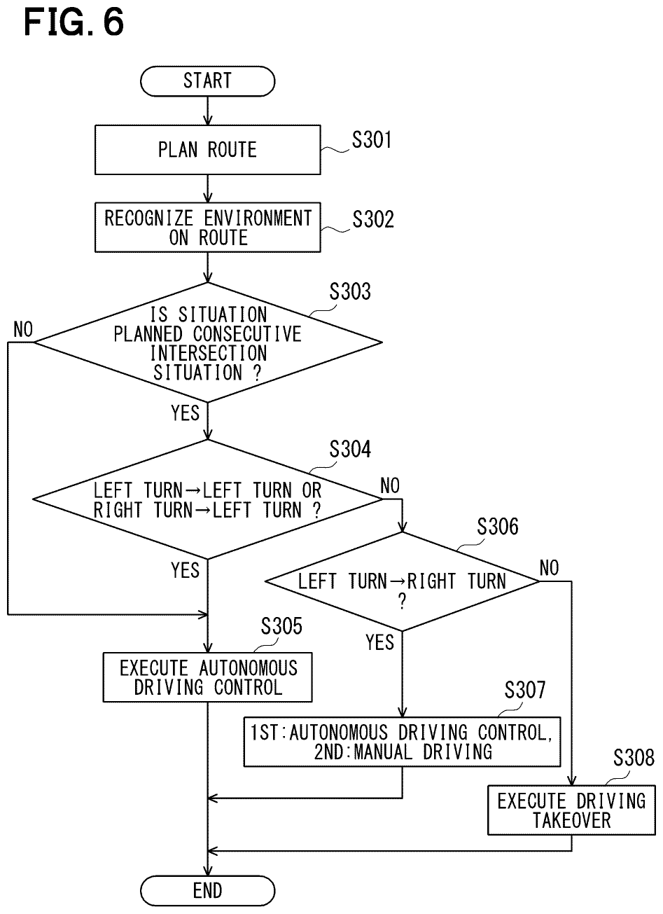

As illustrated in FIG. 6, the third embodiment is a modification of the first embodiment. The third embodiment will be described focusing on differences from the first embodiment.

In the third embodiment, in a case of the pattern (3), the mode setting section 76 sets the autonomous driving mode at the time of passing through the first intersection IS1, that is, at the time of turning left. In addition, the mode setting section 76 sets the manual driving mode when the vehicle passes through the second intersection IS2, that is, when the vehicle turns right. In this manner, the driving-mode switch is executed while the subject vehicle Am is passing through two consecutive intersections IS1 and IS2.

Next, an example of a processing method by the automated driving ECU 50b will be described with reference to a flowchart of FIG. 6. S301 to 305 are similar to S101 to 105. In a case of No in S304, the process proceeds to S306.

In S306, the mode setting section 76 determines whether the traveling direction pattern of the subject vehicle Am at the intersections IS1 and IS2 is the pattern (3). In a case of Yes, the process proceeds to S307. In a case of No, the process proceeds to S308.

In S307, the mode setting section 76 decides to execute autonomous driving control at the first intersection IS1 and to execute manual driving at the second intersection IS2. Based on this, the autonomous driving control and the driving-mode switch are determined to be executed by the action decision section 77 and the control execution section 64. The series of processes terminates at S307. S308 is similar to S106.

According to the third embodiment described above, the subject vehicle Am is scheduled to make a turn in which planar intersection with the oncoming straight vehicle Tm does not occur at the first intersection IS1, and is scheduled to make a turn in which planar intersection with the oncoming straight vehicle Tm occurs at the second intersection IS2. In this traveling direction pattern, the mode related to the automation level is set to a mode in which the autonomous driving control is executed when the vehicle passes through the first intersection IS1. The mode related to the automation level is set to a mode in which the driver is caused to execute manual driving when the vehicle passes through the second intersection IS2. A more appropriate mode at each of the intersections IS1 and IS2 is set according to a difference between the driving control difficulty level at the first intersection IS1 and the driving control difficulty level at the second intersection IS2. Accordingly, convenience is enhanced.

### Fourth Embodiment

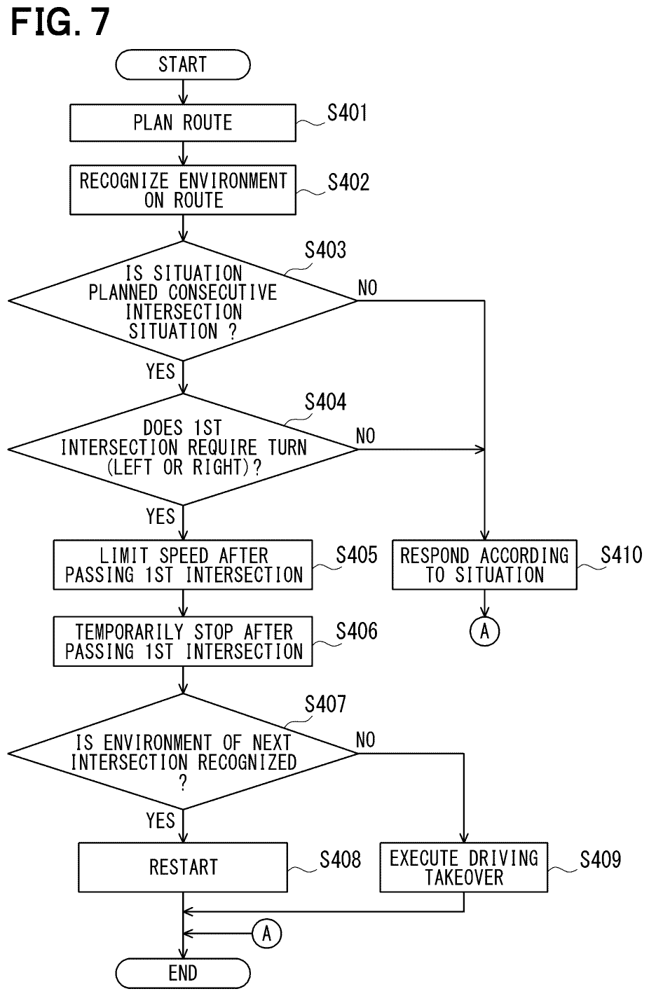

As illustrated in FIG. 7, the fourth embodiment is a modification of the first embodiment. The fourth embodiment will be described focusing on differences from the first embodiment.

In the fourth embodiment, the mode setting section 76 sets the speed limit mode according to the travel control difficulty level for each traveling direction. Specifically, in the consecutive intersections scheduled situation, in a case where the subject vehicle Am turns right or left at the first intersection IS1 (hereinafter, referred to as right or left turn), the speed limit is set so that the speed at which the subject vehicle Am travels at the second or subsequent intersection IS2 is lower than the speed at which the subject vehicle Am travels at the first intersection IS1. The timing at which the speed limit is started may be a timing at which the subject vehicle Am starts traveling on a connection road CR connecting the first intersection IS1 and the second intersection IS2 after turning right or left at the first intersection IS1.

The mode setting section 76 or the action decision section 77 may further decide to temporarily stop the subject vehicle Am after the subject vehicle Am turns right or left at the first intersection IS1 and before entering, for example, the second intersection IS2 under the speed limit. This temporary stop may be released in a case where the mode setting section 76 or the action decision section 77 confirms that the environment recognition section 62 has recognized the environment of the next intersection IS2 using, for example, the surroundings monitoring sensor 30.

On the other hand, in a case where it is not confirmed that the environment of the next intersection IS2 has been recognized within the preset threshold value time from the start of the temporary stop, the mode setting section 76 sets the manual driving mode. Therefore, the driving-mode switch to the driver is executed in the temporarily stopped state. As the threshold value time, for example, a value such as 3 seconds or 5 seconds can be used.

Next, an example of a processing method by the automated driving ECU 50b will be described with reference to a flowchart of FIG. 7. S401 to 403 are similar to S101 to 103. In a case of Yes in S403, the process proceeds to S404. In a case of No, the process proceeds to S411.

In S405, the mode setting section 76 decides to impose the above-described speed limit on the subject vehicle Am after turning right or left at the first intersection IS1. Based on this, the speed at which the vehicle travels at the second or subsequent intersection IS2 is set to be lower than the speed at which the vehicle travels at the first intersection IS1 by the action decision section 77 and the control execution section 64. After the process of S405, the process proceeds to S406.

In S406, the mode setting section 76 or the action decision section 77 further decides to temporarily stop the subject vehicle Am before entering the second intersection IS2. Based on this, the action decision section 77 and the control execution section 64 temporarily stop the subject vehicle Am. After the process of S406, the process proceeds to S407.

In S407, the mode setting section 76 or the action decision section 77 determines whether the environment of the next intersection IS2 has been recognized. In a case where it is confirmed that the recognition has been performed within the preset threshold value time (Yes), the process proceeds to S408. Otherwise (No), the process proceeds to S409.

In S408, the mode setting section 76 or the action decision section 77 decides to release the temporary stop of the subject vehicle Am. The subject vehicle Am restarts and enters the second intersection IS2. The series of processes terminates at S408.

Further, S409 is similar to S106. In S410, the mode setting section 76 decides a response (mode) according to each situation. The series of processes terminates at S409 or S410.

According to the fourth embodiment described above, the subject vehicle Am is scheduled to make a turn at the first intersection IS1 among the plurality of consecutive intersections IS1 and IS2. In a case of being scheduled to make a turn at the first intersection IS1, it is difficult to recognize the environment of the second intersection IS2 using the surroundings monitoring sensor 30 unless after the turn. Therefore, in this traveling direction pattern, the speed limit is set so that the speed at which the vehicle travels at the second or subsequent intersection IS2 is lower than the speed at which the vehicle travels at the first intersection IS1. Further, the speed limit may be set from the road before the subject vehicle Am enters the second intersection IS2. With such speed limitation, the time from the passage through the first intersection IS1 to the entry into the second intersection IS2 can be lengthened, so that the environment of the second intersection IS2 can be easily recognized.

In addition, after the subject vehicle Am turns at the first intersection IS1, it may be determined to further temporarily stop the subject vehicle Am under the speed limit. Since the subject vehicle Am can recognize the environment of the second intersection IS2 in the temporary stop state, the recognition accuracy can be further improved.

In addition, the temporary stop may be released in a case where it is confirmed that the subject vehicle Am has recognized the environment of the next intersection IS1. Unnecessary continuation of the temporary stop can be suppressed, so that disturbance of the traffic flow is suppressed and convenience is enhanced.

In addition, in the temporary stop, in a case where it cannot be confirmed that the subject vehicle Am has recognized the environment of the next intersection IS2 within a preset threshold value time, a mode for causing the driver to execute manual driving is set. Since the driver recognizes the environment and manually drives the vehicle, it is possible to avoid continuation of a temporary stop that disturbs a traffic flow, and thus convenience is enhanced.

### Fifth Embodiment

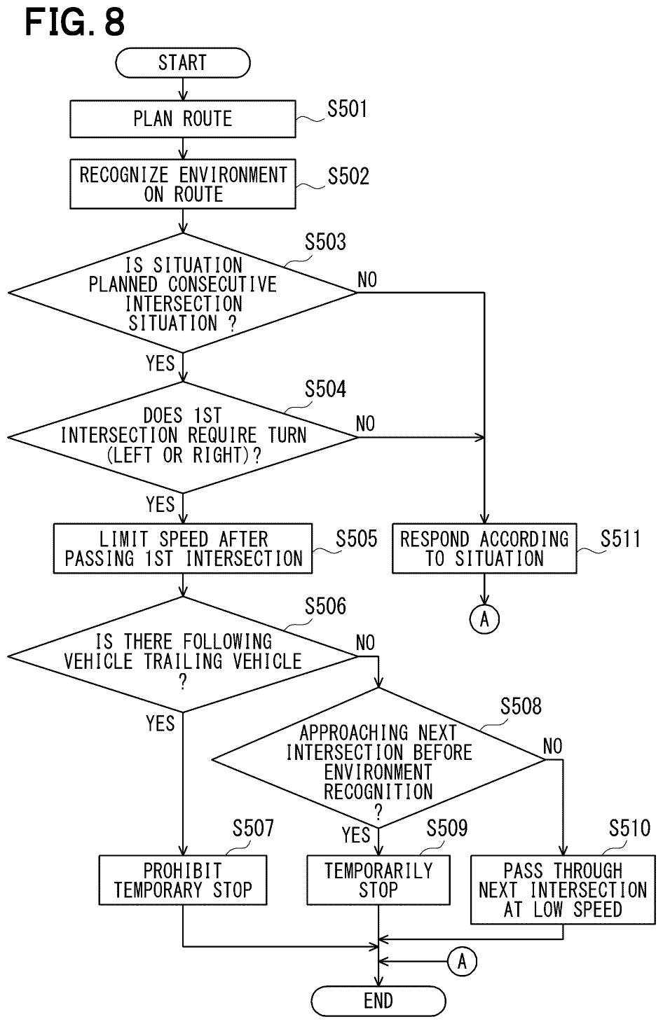

As illustrated in FIG. 8, the fifth embodiment is a modification of the fourth embodiment. The fifth embodiment will be described focusing on differences from the fourth embodiment.

In the fifth embodiment, the mode setting section 76 or the action decision section 77 decides whether to stop temporarily before entering the intersection IS2 according to whether the subject vehicle Am has approached the intersection IS2 without being confirmed that the environment of the second intersection IS2 has been recognized. In a case where the subject vehicle Am approaches the intersection IS2 without being confirmed that the environment of the second intersection IS2 has been recognized, the subject vehicle Am temporarily stops. In a case where the environment of the intersection IS2 can be recognized before the subject vehicle Am approaches the second intersection IS2, the subject vehicle Am enters the intersection IS2 without stopping temporarily.

In a case where it is confirmed that there is a following vehicle following the subject vehicle Am after the subject vehicle Am turns right or left at the first intersection IS1, the mode setting section 76 prohibits the subject vehicle Am from temporarily stopping before the subject vehicle Am enters the next intersection IS2. In other words, the mode setting section 76 sets the temporary stop prohibition mode. That is, subject vehicle Am enters next intersection IS2 without stopping temporarily.

Next, an example of a processing method by the automated driving ECU 50b will be described with reference to a flowchart of FIG. 8. S501 to 505 are similar to S401 to 405. In a case of No in S503 or S504, the process proceeds to S511. S511 is similar to S410. After the process of S505 to which the process proceeds in a case of Yes in S503 and S504, the process proceeds to S506.

In S506, the mode setting section 76 or the action decision section 77 determines whether there is a following vehicle following the subject vehicle Am. In a case of Yes, the process proceeds to S507. In a case of No, the process proceeds to S508.

In S507, the mode setting section 76 prohibits the temporary stop of the subject vehicle Am. The subject vehicle Am enters the second intersection IS2 without temporarily stopping. The series of processes terminates at S507.

In S508, the mode setting section 76 or the action decision section 77 determines whether the subject vehicle Am has approached the intersection IS2 without being confirmed that the environment of the second intersection IS2 has been recognized. In a case of Yes, the process proceeds to S509. In a case of No, the process proceeds to S510.

In S509, the mode setting section 76 or the action decision section 77 decides to temporarily stop the subject vehicle Am. The release of the temporary stop may be performed under conditions similar to those in the fourth embodiment, or may be performed under other conditions. The series of processes terminates at S509.

According to the fifth embodiment described above, after the subject vehicle Am turns at the first intersection IS1, in a case where the subject vehicle Am approaches the intersection IS2 without being confirmed that the subject vehicle Am has recognized the environment of the next intersection IS2 under the speed limit, the subject vehicle Am is temporarily stopped. The determination of the temporary stop based on whether the environment is recognized is suspended until the intersection IS2 is approached with high determination accuracy. Therefore, the occurrence of unnecessary temporary stop can be suppressed, and convenience is enhanced.

In a case where the presence of a following vehicle following the subject vehicle Am is confirmed after the subject vehicle Am turns at the first intersection IS1, the subject vehicle Am is prohibited from temporarily stopping. Since it is possible to suppress the occurrence of turbulence of the traffic flow and the occurrence of rear-end collision due to the temporary stop of the subject vehicle Am, convenience is enhanced.

### Sixth Embodiment

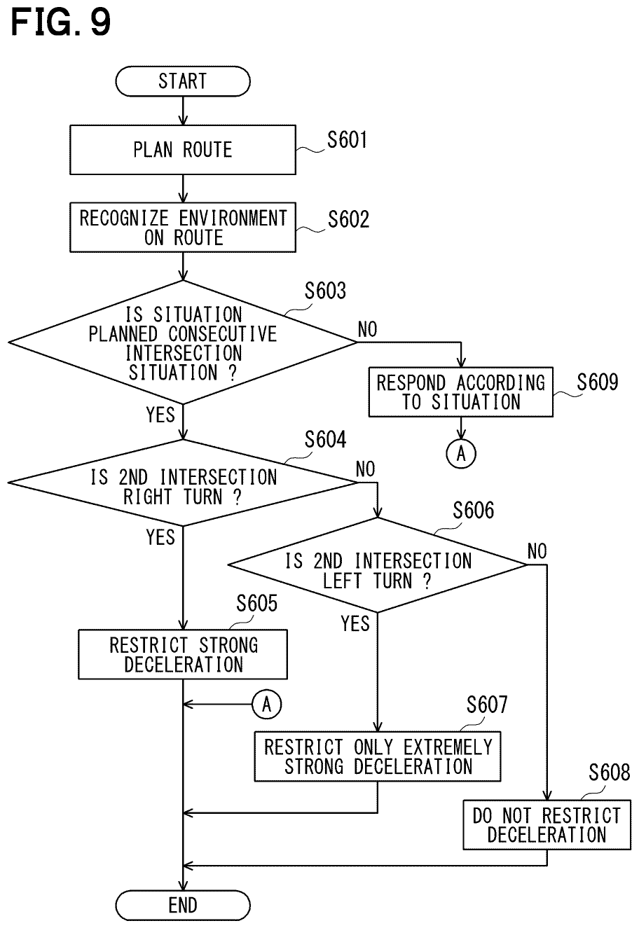

As illustrated in FIG. 9, the sixth embodiment is a modification of the first embodiment. The sixth embodiment will be described focusing on differences from the first embodiment.

In the sixth embodiment, the mode setting section 76 sets the deceleration limit mode according to the traveling direction at the second intersection IS2. The mode setting section 76 sets the deceleration limit mode until the vehicle enters the second intersection IS2 after passing through the first intersection IS1.

Specifically, the mode setting section 76 imposes the most severe deceleration limit on the subject vehicle Am in a case where the subject vehicle Am turns right at the second intersection IS2. The mode setting section 76 imposes a looser deceleration limit on the subject vehicle Am in a case where the subject vehicle Am turns left at the second intersection IS2 than in a case where the subject vehicle Am turns right. For example, the lower limit value of the deceleration represented by −dv/dt is set to −Da in a case of a right turn, and the lower limit value is set to −Db (>−Da) in a case of a left turn. That is, in a case of a right turn, the subject vehicle Am can travel with a weak deceleration, and in a case of a left turn, the subject vehicle Am can travel with a stronger deceleration. In addition, in a case where the subject vehicle Am goes straight through the second intersection IS2, the mode setting section 76 may not set the deceleration limit mode.

Next, an example of a processing method by the automated driving ECU 50b will be described with reference to a flowchart of FIG. 9. S601 to 603 are similar to S101 to 103. In a case of No in S603, the process proceeds to S609. S609 is similar to S410. In a case of Yes in S603, the process proceeds to S604.

In S604, the mode setting section 76 determines whether the subject vehicle Am is scheduled to turn right at the second intersection IS2. In a case of Yes, the process proceeds to S605. In a case of No, the process proceeds to S606.

In S605, the mode setting section 76 restricts the deceleration stronger than that in a case of the left turn. Based on this, the subject vehicle Am starts deceleration from an early stage, for example, immediately after passing through the first intersection IS1 in order to sufficiently reduce the speed of entering the second intersection IS2. That is, subject vehicle Am travels for a time longer than that in a case of a left turn on connection road CR connecting first intersection IS1 and second intersection IS2. The series of processes terminates at S605.

In S606, the mode setting section 76 determines whether the subject vehicle Am is scheduled to turn left at the second intersection IS2. In a case of Yes, the process proceeds to S607. In a case of No, the process proceeds to S608.

In S607, the mode setting section 76 restricts only extremely strong deceleration and allows strong deceleration in a case of right turn. In order to sufficiently reduce the speed at which the subject vehicle Am enters the second intersection IS2, the subject vehicle Am executes strong deceleration immediately before the entry. As a result, the subject vehicle Am can pass through the connection road CR in a time relatively shorter than that in a case of turning right. The series of processes terminates at S607.

In S608 in a case of going straight at the second intersection IS2, the mode setting section 76 does not particularly restrict deceleration. The series of processes terminates at S608.

According to the sixth embodiment described above, a mode having a different deceleration limit is set according to the traveling direction at the second intersection IS2. For example, stronger deceleration may be restricted in a case where the subject vehicle Am is scheduled to make a turn in which planar intersection with the oncoming straight vehicle Tm occurs, than in a case where the subject vehicle Am is scheduled to make a turn in which planar intersection with the oncoming straight vehicle Tm does not occur. In the turn with a high driving control difficulty level, strong deceleration is allowed, and the traveling speed of the subject vehicle Am is reduced early, so that time until the environment of the second intersection IS2 is recognized can be gained. As a result, it is possible to improve the accuracy of the autonomous driving control when passing through the second intersection IS2.

### Seventh Embodiment

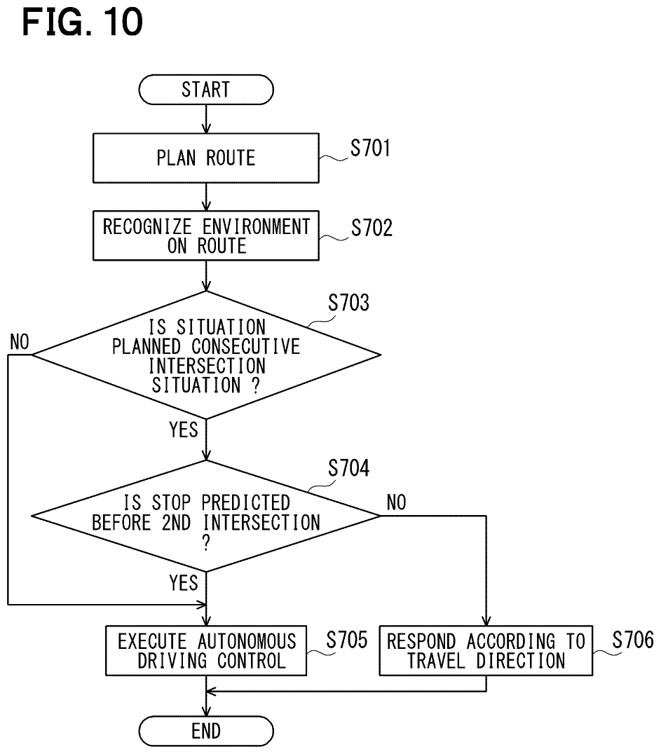

As illustrated in FIG. 10, the seventh embodiment is a modification of the first embodiment. The seventh embodiment will be described focusing on differences from the first embodiment.

In the seventh embodiment, the mode setting section 76 predicts whether the subject vehicle Am stops before entering the second intersection IS2. The cause of the stop of the subject vehicle Am may be that the traffic signal TS2 indicates a stop signal at the second intersection IS2 or may be traffic congestion. This prediction is possible, for example, when the environment recognition section 62 acquires traffic signal information and congestion information through the in-vehicle communication device 39. In a case where the mode setting section 76 predicts that the subject vehicle Am will stop, it sets the autonomous driving mode regardless of the driving control difficulty level for each traveling direction.

Next, an example of a processing method by the automated driving ECU 50b will be described with reference to a flowchart of FIG. 10. S701 to 703 are similar to S101 to 103. In a case of Yes in S703, the process proceeds to S704. In a case of No, the process proceeds to S705.

In S704, the mode setting section 76 executes prediction and determines whether the subject vehicle Am is predicted to stop before entering the second intersection IS2. In a case of Yes, the process proceeds to S705. In a case of No, the process proceeds to S706.

S705 is similar to S105. In S706, the mode setting section 76 sets the mode according to the driving control difficulty level for each traveling direction. For example, the mode setting as in the first embodiment can be used. The series of processes terminates at S705 or S706.

According to the seventh embodiment described above, in a case where the subject vehicle Am is predicted to stop before entering the second intersection IS2 due to the traffic signal TS2 indicating a stop signal at the second intersection IS2 or traffic congestion, a mode for executing autonomous driving control is set. Since the subject vehicle Am temporarily stops before entering the second intersection IS2, the movement of the subject vehicle Am can be divided once between the intersections IS1 and IS2. Since it is possible to separately plan the action at the first intersection IS1 and the action at the second intersection IS2, the difficulty level of the driving control decreases. As a result, even when the autonomous driving control is executed, the occurrence of a situation exceeding the ability is suppressed.

### Eighth Embodiment

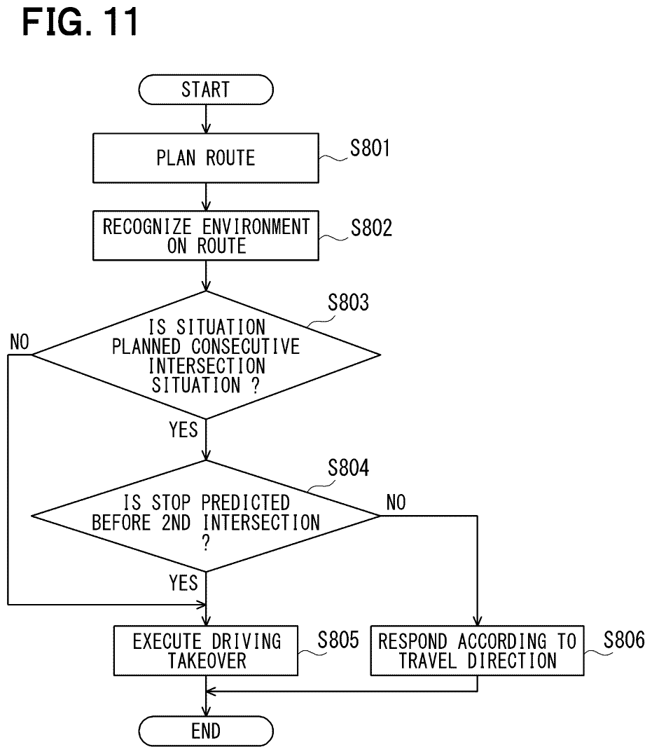

As illustrated in FIG. 11, the eighth embodiment is a modification of the seventh embodiment. The seventh embodiment will be described focusing on differences from the first embodiment.

In the eighth embodiment, in a case where the mode setting section 76 predicts that the subject vehicle Am will stop at the second intersection IS2, it set the manual driving mode regardless of the driving control difficulty level for each traveling direction. As in the processing method illustrated in the flowchart of FIGS. 11, S801 to 804, and 806 are similar to S701 to 704, and 706. S805 is similar to S106.

According to this, in a case where the subject vehicle Am is predicted to stop before entering the second intersection IS2 due to the traffic signal TS2 indicating a stop signal at the second intersection IS2 or traffic congestion, a mode for causing the driver to execute manual driving is set. In a case of the autonomous driving control, there is a high possibility that the subject vehicle Am will travel slowly, so that by executing smooth manual driving by the driver instead of the autonomous driving control, convenience is enhanced.

### Ninth Embodiment

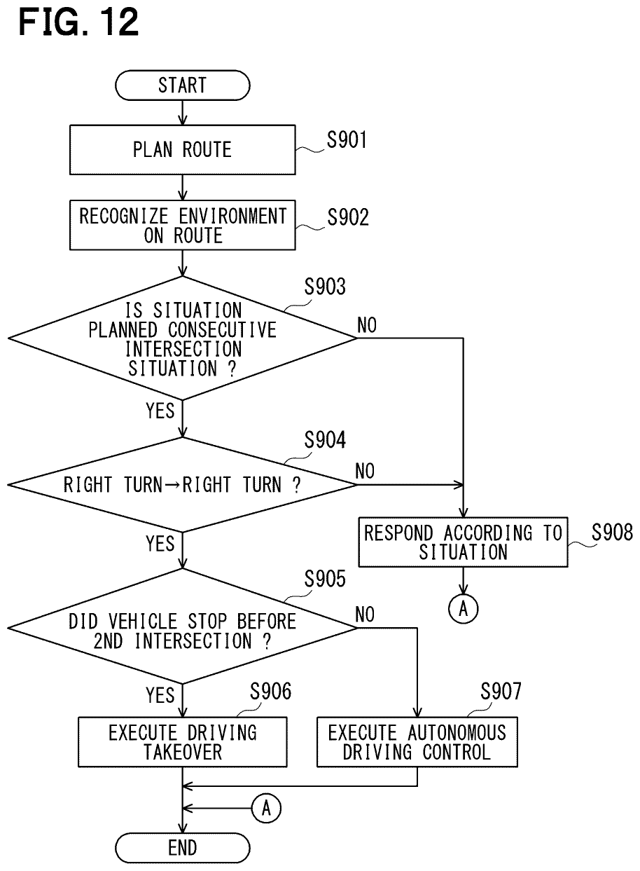

As illustrated in FIG. 12, the ninth embodiment is a modification of the first embodiment. The ninth embodiment will be described focusing on differences from the first embodiment.

In the ninth embodiment, in a case of the pattern (4), in a case where the subject vehicle Am stops before entering the second intersection IS2 after passing through the first intersection IS1, the mode setting section 76 sets the manual driving mode while the subject vehicle Am stops. The cause of the stop of the subject vehicle Am may be that the traffic signal TS2 indicates a stop signal at the second intersection IS2, or may be that traffic congestion occurs at the second intersection IS2.

Next, an example of a processing method by the automated driving ECU 50b will be described with reference to a flowchart of FIG. 12. S901 to 903 are similar to S101 to 103. In a case of Yes in S903, the process proceeds to S904. In a case of No, the process proceeds to S908. S908 is similar to S410.

In S904, the mode setting section 76 determines whether the traveling direction pattern of the subject vehicle Am at the intersections IS1 and IS2 is the pattern (4). In a case of Yes, the process proceeds to S905. In a case of No, the process proceeds to S908.

In S905, the mode setting section 76 determines whether the subject vehicle Am has stopped before entering the second intersection IS2. In a case of Yes, the process proceeds to S906. In a case of No, the process proceeds to S907. S906 is similar to 106. S907 is similar to S105. The series of processes terminates at S906 or S907.

According to the ninth embodiment described above, the subject vehicle Am is scheduled to make a turn in which a planar intersection with the oncoming straight vehicle Tm occurs at the first intersection IS1, and is scheduled to make a turn in which a planar intersection with the oncoming straight vehicle Tm occurs at the second intersection IS2. In this traveling direction pattern, in a case where the subject vehicle Am is predicted to stop before entering the second intersection IS2 due to the traffic signal TS2 indicating a stop signal at the second intersection IS2 or traffic congestion, a mode for causing the driver to execute manual driving is set after the subject vehicle Am actually stops. Since the driver can actually check the safety and perform the manual driving when passing through the second intersection IS2, the convenience is enhanced.

### Tenth Embodiment

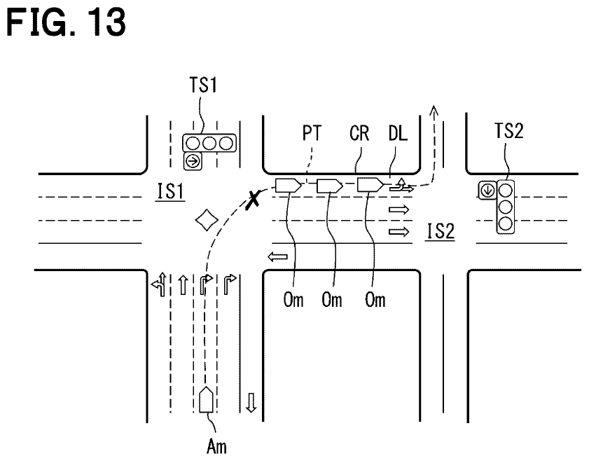

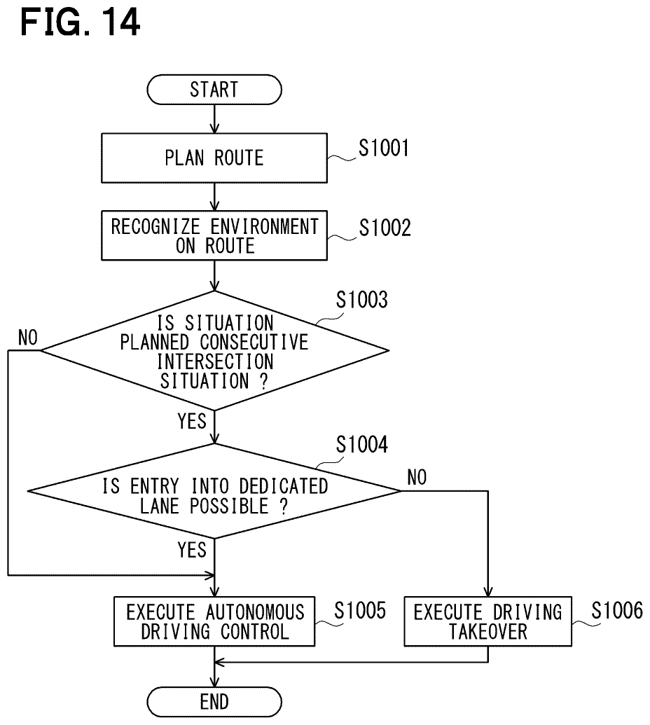

As illustrated in FIGS. 13 and 14, the tenth embodiment is a modification of the first embodiment. The tenth embodiment will be described focusing on differences from the first embodiment.

In the tenth embodiment, the mode setting section 76 determines whether the subject vehicle Am can enter the dedicated lane DL for traveling in the traveling direction scheduled for the second intersection IS2 on the connection road CR connecting the first intersection IS1 and the second intersection IS2. For example, as illustrated in FIG. 13, a case is considered where the subject vehicle Am is about to turn left at the second intersection IS2, and a lane that allows a left turn as the dedicated lane DL in the connection road CR is filled with another vehicle Om due to traffic congestion. In this case, the subject vehicle Am is not allowed to enter the dedicated lane DL. In a case where it is determined that entry into the dedicated lane DL is impossible, the mode setting section 76 sets the manual driving mode.

Next, an example of a processing method by the automated driving ECU 50b will be described with reference to a flowchart of FIG. 14. S1001 to 1003 are similar to S101 to 103. In a case of Yes in S1003, the process proceeds to S1004. In a case of No, the process proceeds to S1005.

In S1004, the mode setting section 76 determines whether the subject vehicle Am can enter the dedicated lane DL described above. In a case of Yes, the process proceeds to S1005. In a case of No, the process proceeds to S1006. S1005 to 1006 are similar to S105 to 106. The series of processes terminates at S1005 or S1006.

According to the tenth embodiment described above, it is determined that the subject vehicle Am is not allowed to enter the dedicated lane DL for traveling in the traveling direction scheduled for the second intersection IS2 on the connection road CR. In this case, a mode for causing the driver to execute manual driving is set. Continuation of the autonomous driving control in a situation exceeding the ability of the autonomous driving control is suppressed, so that convenience can be enhanced.

### Eleventh Embodiment

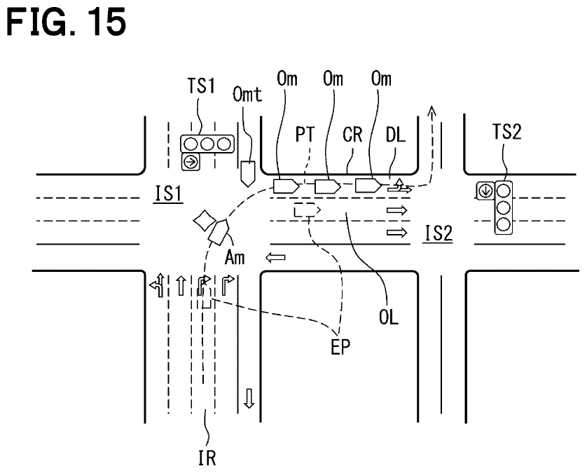

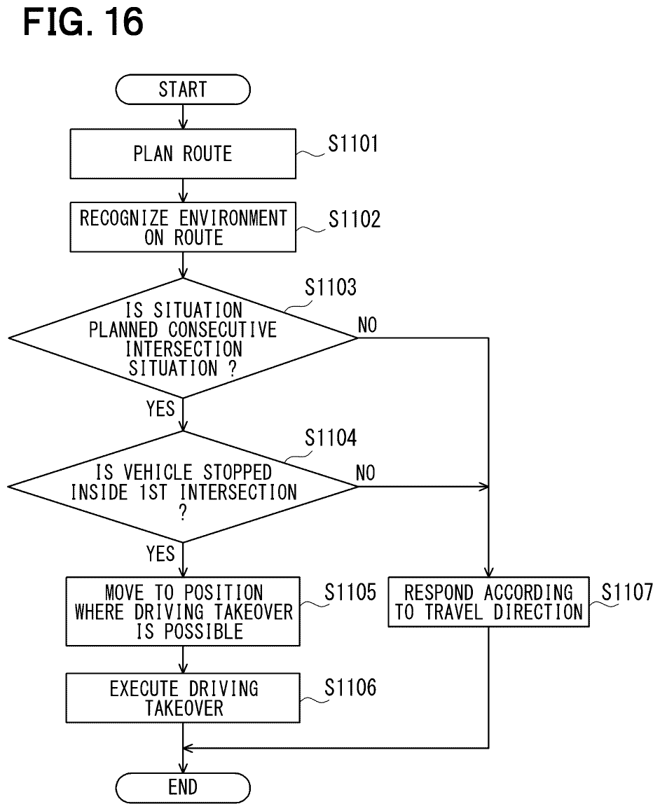

As illustrated in FIGS. 15 and 16, the eleventh embodiment is a modification of the first embodiment. The eleventh embodiment will be described focusing on differences from the first embodiment.

In the eleventh embodiment, the environment recognition section 62 grasps a situation in which the subject vehicle Am is stuck in the first intersection IS1 and is not allowed to pass through the first intersection IS1. Under this situation, after the mode setting section 76 sets the autonomous driving mode, the action decision section 77 decides to evacuate the subject vehicle Am to the position EP where the driving-mode switch can be easily executed. After the evacuation, the mode setting section 76 sets the manual driving mode, and the driving-mode switch is executed.

For example, as illustrated in FIG. 15, the evacuation is executed in a case where, on the connection road CR connecting the first intersection IS1 and the second intersection IS2, the subject vehicle Am is not allowed to enter the dedicated lane DL for the subject vehicle Am to travel in the traveling direction scheduled for the second intersection IS2, and the subject vehicle Am is stuck in the first intersection IS1. In addition, the evacuation may be executed in a case where the oncoming vehicle OMt at the first intersection IS1 blocks the traveling direction of the subject vehicle Am and the subject vehicle Am is stuck in the first intersection IS1.

For example, as illustrated in FIG. 15, the position EP where the driving-mode switch can be easily executed may be a lane OL where a space for the subject vehicle Am is securable other than the dedicated lane DL described above in the connection road CR. Further, the position EP at which the driving-mode switch can be easily executed may be a road IR on which the subject vehicle Am has traveled before entering the first intersection IS1. In this case, the subject vehicle Am is evacuated by retreating.

Next, an example of a processing method by the automated driving ECU 50b will be described with reference to a flowchart of FIG. 16. S1101 to 1103 are similar to S101 to 103. In a case of Yes in S1103, the process proceeds to S1104. In a case of No, the process proceeds to S1107.

In S1104, the mode setting section 76 determines whether the subject vehicle Am is stuck in the first intersection IS1 and is not allowed to pass through the first intersection IS1. In a case of Yes, the process proceeds to S1105. In a case of No, the process proceeds to S1107.

In S1105, the action decision section 77 decides to evacuate the subject vehicle Am to the position EP where the driving-mode switch can be easily executed. After the process of S1105, the process proceeds to S1106.

S1106 is similar to S106. Further, S1107 are similar to S706. The series of processes terminates at S1106 or S1107.

According to the eleventh embodiment described above, in a case where the subject vehicle Am is stuck in the first intersection IS1 and is not allowed to pass through the first intersection IS1, it is determined that the subject vehicle Am is evacuated to a position DR where the driving-mode switch to the driver can easily executed by the autonomous driving control. Since the driving-mode switch can be smoothly executed at the evacuation position DR in this way, convenience is enhanced.

### Twelfth Embodiment

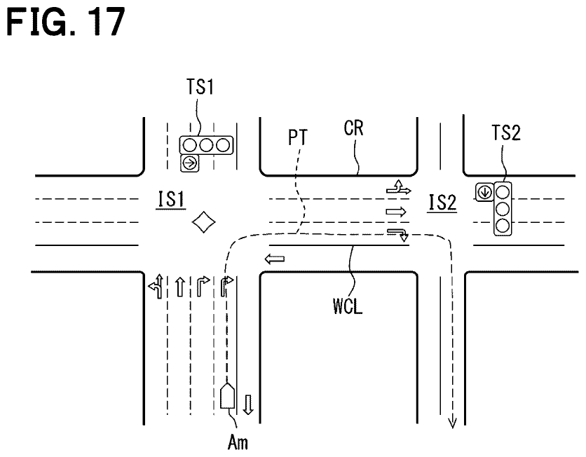

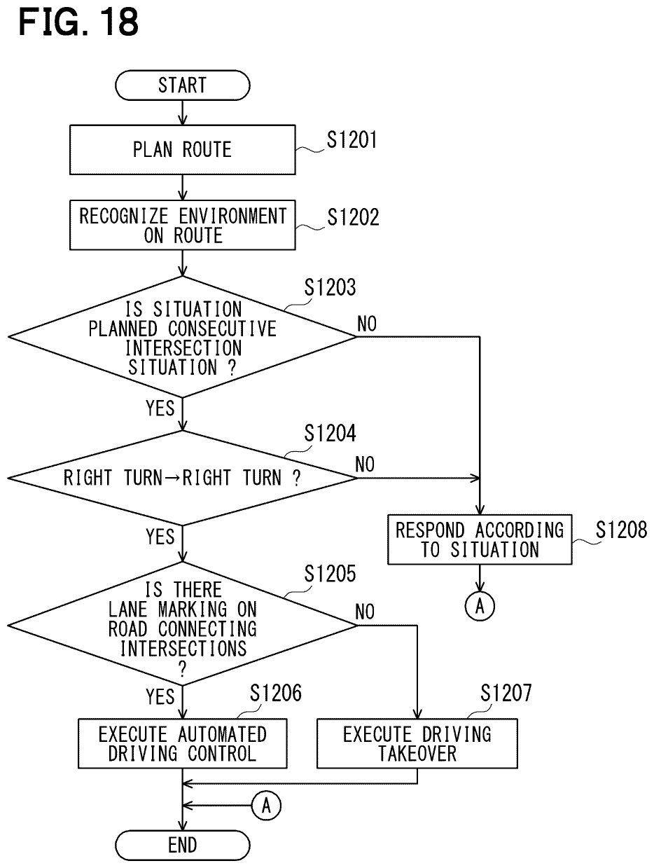

As illustrated in FIGS. 17 and 18, the twelfth embodiment is a modification of the first embodiment. The twelfth embodiment will be described focusing on differences from the first embodiment.

In the twelfth embodiment, in a case of the pattern (4), the mode setting section 76 sets the mode related to automation according to whether there is the section line WCL of the opposite lane on the connection road CR connecting the first intersection IS1 and the second intersection IS2.

For example, in a case where the section line WCL is present on an arterial road or the like having a large width, the surroundings monitoring sensor 30 can recognize the section line WCL and can perform autonomous driving control based on the section line WCL, so that the driving control difficulty level is relatively low. Therefore, the mode setting section 76 sets the autonomous driving mode.

On the other hand, for example, in a case where the section line WCL is not present on a road or the like having a narrow width of an alley in a residential area, a target used as a reference of autonomous driving control is poor, and thus the driving control difficulty level is relatively high. Therefore, mode setting section 76 sets the manual driving mode.

Next, an example of a processing method by the automated driving ECU 50b will be described with reference to a flowchart of FIG. 18. S1201 to 1203 are similar to S101 to 103. In a case of Yes in S1203, the process proceeds to S1204. In a case of No, the process proceeds to S1208. S1208 is similar to S410.

In S1204, the mode setting section 76 determines whether the traveling direction pattern of the subject vehicle Am at the intersections IS1 and IS2 is the pattern (4). The pattern (4) may be substantially a U-turn. In a case of Yes, the process proceeds to S1205. In a case of No, the process proceeds to S1208.

In S1205, the mode setting section 76 determines whether there is the section line WCL of the opposite lane on the connection road CR. In a case of Yes, the process proceeds to S1206. In a case of No, the process proceeds to S1207. S1206 to 1207 are similar to S105 to 106. The series of processes terminates at S1206 or S1207.

According to the twelfth embodiment described above, in a case where the section line WCL of the opposite lane is present on the connection road CR, the mode for executing the autonomous driving control is set. In addition, in a case where the section line WCL is not present, the mode for causing the driver to execute manual driving is set. Since a more appropriate mode is set based on the difference in the driving control difficulty level depending on the presence or absence of the section line WCL, convenience is enhanced.

### Thirteenth Embodiment

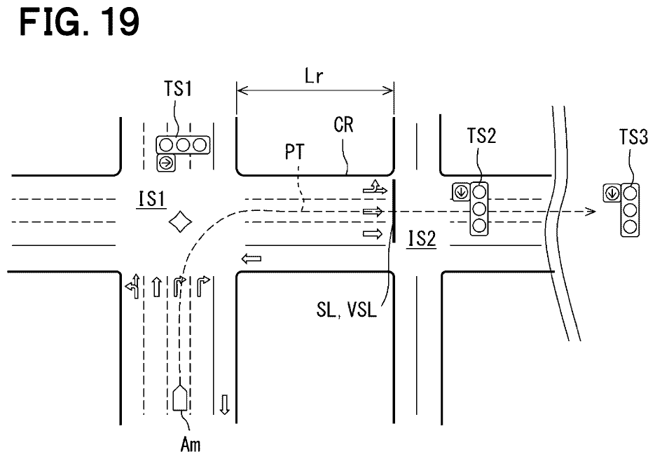

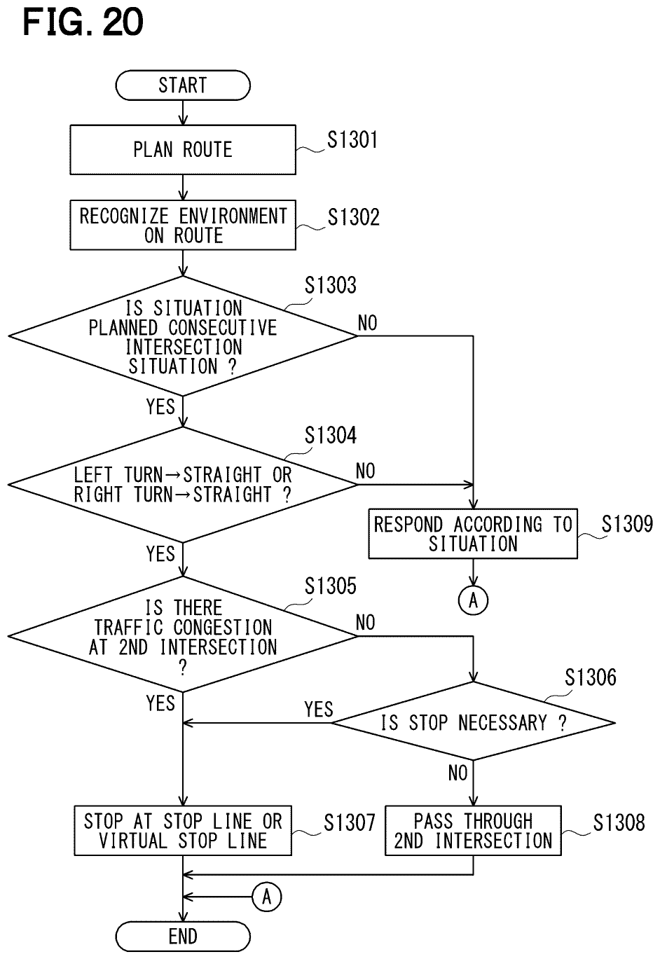

As illustrated in FIGS. 19 and 20, the thirteenth embodiment is a modification of the first embodiment. The thirteenth embodiment will be described focusing on differences from the first embodiment.

In the thirteenth embodiment, the driving control difficulty level is set for a traveling direction pattern in which the subject vehicle Am goes straight at one of the first intersection IS1 and the second intersection IS2 and makes a right turn or a left turn at the other intersection.

For example, the driving control difficulty level is the lowest in the pattern (5), and the difficulty level is higher in order of the pattern (6), the pattern (7), and the pattern (8). The pattern (5) is a pattern in which the vehicle goes straight at the first intersection IS1 and turns left at the second intersection IS2 (going straight→turning left). The pattern (6) is a pattern in which the vehicle goes straight at the first intersection IS1 and turns right at the second intersection IS2 (going straight→turning right). The pattern (7) is a pattern in which the vehicle turns left at the first intersection IS1 and goes straight at the second intersection IS2 (turning left→going straight). The pattern (8) is a pattern in which the vehicle turns right at the first intersection IS1 and goes straight at the second intersection IS2 (turning right→going straight).

Since the patterns (5) to (8) defined here have lower driving difficulty levels than the patterns (1) to (4), the mode setting section 76 sets the autonomous driving mode in any patterns.

In the patterns (5) and (6), only one right or left turn is executed after going straight, so that the driving control difficulty level at a single intersection does not greatly change. On the other hand, in the patterns (7) and (8), it is necessary to execute driving in consideration of the environment after the second intersection IS2 after executing the right or left turn at the first intersection IS1. Therefore, the mode setting section 76 sets a mode for executing the more complicated determination process in a case of the patterns (7) and (8) than in the patterns (5) and (6).

Specifically, in a case where traffic congestion occurs at the second intersection IS2, the mode setting section 76 sets a stop mode for stopping the subject vehicle Am at a stop line SL before entering the second intersection IS2. Based on this, the action decision section 77 decides to stop the subject vehicle Am at the stop line SL.

Here, in a case where the stop line SL is actually provided before entering the second intersection IS2, the subject vehicle Am is stopped in accordance with the stop line SL. On the other hand, in a case where the stop line SL is not provided, the mode setting section 76 or the action decision section 77 sets a virtual stop line VSL (see FIG. 19). The subject vehicle Am is stopped in accordance with the virtual stop line VSL. The virtual stop line VSL may be set based on the intersection shape detected by the surroundings monitoring sensor 30. Alternatively, the highly accurate map data may be configured in advance as data including the virtual stop line VSL. In this case, the mode setting section 76 or the action decision section 77 acquires the position of the virtual stop line VSL from a map DB 36.

Further, in a case where a traffic signal TS3 is installed ahead of the subject vehicle Am going straight through the second intersection IS2, the mode setting section 76 considers the traffic signal TS3 (see FIG. 19). The traffic signal TS3 here may be a traffic signal of a third intersection continuous with the second intersection IS2, or may be a traffic signal installed for some reason other than the intersection. Here, it is assumed that the traffic signal TS3 is installed at a distance at which interaction with the second intersection IS2 can occur, for example, a distance equal to or less than a threshold value set in a range of 150 to 300 m from the second intersection IS2.

In a case where the traffic signal TS3 indicates a stop signal, the mode setting section 76 individually and specifically determines whether it is necessary to stop before the subject vehicle Am enters the second intersection IS2 of based on the road information. The road information referred to herein includes a road shape obtained from the highly accurate map data, the presence or absence of the stop line SL with respect to the preceding traffic signal TS3, congestion information near the preceding traffic signal TS3, and the like. In a case of determining that the stop is necessary, the mode setting section 76 sets the stop mode.

Next, an example of a processing method by the automated driving ECU 50b will be described with reference to a flowchart of FIG. 20. S1301 to 1303 are similar to S101 to 103. In a case of Yes in S1303, the process proceeds to S1304. In a case of No, the process proceeds to S1309. S1309 is similar to S410.

In S1304, the mode setting section 76 determines whether the traveling direction pattern of the subject vehicle Am at the intersections IS1 and IS2 is the pattern (7) or (8). In a case of Yes, the process proceeds to S1305. In a case of No, the process proceeds to S1309.

In S1305, the mode setting section 76 determines whether traffic congestion has occurred at the second intersection IS2. In a case of Yes, the process proceeds to S1307. In a case of No, the process proceeds to S1306.

In S1306, the mode setting section 76 determines whether the traffic signal TS3 installed ahead of the second intersection IS2 where the subject vehicle Am goes straight indicates a stop signal, and accordingly, whether it is necessary to stop before entering the second intersection IS2 of the subject vehicle Am. In a case of Yes, the process proceeds to S1307. In a case of No, the process proceeds to S1308.

In S1307, the mode setting section 76 or the action decision section 77 decides to stop the subject vehicle Am at the stop line SL or the virtually set virtual stop line VSL. Based on this, the control execution section 64 stops the subject vehicle Am before the subject vehicle Am enters the second intersection IS2 by the autonomous driving control. The series of processes terminates at S1307.

In S1308, the mode setting section 76 does not set a restriction to stop the subject vehicle Am at the second intersection IS2. Based on this, the subject vehicle Am is caused to pass through the second intersection IS2 by the autonomous driving control by the action decision section 77 and the control execution section 64. The series of processes terminates at S1308.

According to the thirteenth embodiment described above, the stop line SL is not present on the route PT of the subject vehicle Am at the second intersection IS2 among the plurality of consecutive intersections IS1 and IS2. With respect to the intersections IS1 and IS2, the subject vehicle Am is scheduled to make a turn at the first intersection IS1 and go straight at the second intersection IS2. In this traveling direction pattern, in a case where traffic congestion occurs at the second intersection IS2, the virtual stop line VSL is set on the road CR before entering the second intersection IS2, and the subject vehicle Am is stopped at the virtual stop line VSL. By setting the virtual stop line VSL and controlling the subject vehicle Am with the virtual stop line VSL as a target, even in a case where there is no actual stop line SL, the driving control difficulty level can be lowered and the autonomous driving control can be continued. Since the occurrence of a situation exceeding the ability of the autonomous driving control can be suppressed, convenience is enhanced.

In addition, in a case where the traffic signal TS3 ahead of the second intersection IS2 where the vehicle goes straight indicates a stop signal, it is determined whether it is necessary to stop before the subject vehicle Am enters the second intersection IS2 of based on the road information. The necessity of the stop is determined based on the individual specific road information, so that the accuracy of the autonomous driving control can be enhanced.

### Fourteenth Embodiment

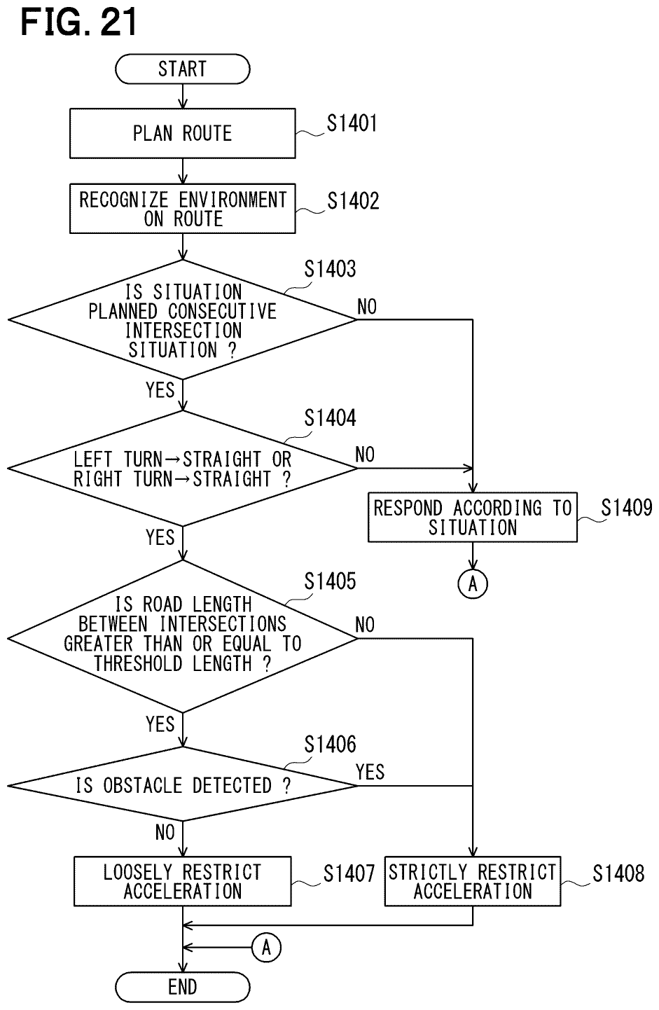

As illustrated in FIGS. 19 and 21, the fourteenth embodiment is a modification of the thirteenth embodiment. The thirteenth embodiment will be described focusing on differences from the first embodiment.

In the fourteenth embodiment, the mode setting section 76 sets the acceleration limit mode instead of the stop mode. The mode setting section 76 sets different acceleration limit modes according to a length Lr (see FIG. 19) of the connection road CR connecting the plurality of consecutive intersections IS1 and IS2.

The acceleration limit mode includes, for example, an acceleration limit mode (A) and an acceleration limit mode (B) as a plurality of modes having different upper limits of acceleration. The acceleration limit mode (A) is a mode that imposes a relatively strict acceleration limit, and the upper limit value Aa of the acceleration represented by dv/dt is set to a positive value but is set to a value close to 0. The acceleration limit mode (B) is a mode that imposes a relatively loose acceleration limit, and the upper limit Ab of the acceleration is set to a value larger than Aa. Although the acceleration limit mode (B) is a mode in which the acceleration restriction is loose, for example, in a situation where the subject vehicle Am travels on a simple straight road without an intersection, the acceleration is not restricted. Therefore, it can be said that the acceleration is restricted more strongly than in this situation.

The mode setting section 76 sets the acceleration limit mode (B) in a case where the length Lr of the connection road CR is equal to or longer than a preset threshold value length. The mode setting section 76 sets the acceleration limit mode (A) in a case where the length Lr of the connection road CR is equal to or less than the threshold value length. The threshold value length may be, for example, 75 m.

Even in a case where the length Lr of the connection road CR is greater than or equal to the threshold value length, the mode setting section 76 may set the acceleration limit mode (A) in a case where an obstacle is confirmed ahead of and behind the subject vehicle Am. The obstacle referred to herein is a following vehicle following the subject vehicle Am, a pedestrian who may jump out in front of the subject vehicle Am, or the like.

Next, an example of a processing method by the automated driving ECU 50b will be described with reference to a flowchart of FIG. 21. S1401 to 1404 are similar to S1301 to 1304. In a case of No in S1403 and S1404, the process proceeds to S1409. S1409 is similar to S410. In a case of Yes in S1404, the process proceeds to S1405.

In S1405, the mode setting section 76 determines whether the length Lr of the connection road CR is greater than or equal to the threshold value length. In a case of Yes, the process proceeds to S1406. In a case of No, the process proceeds to S1408.

In S1406, the mode setting section 76 determines whether an obstacle is confirmed ahead of and behind the subject vehicle Am. In a case of Yes, the process proceeds to S1408. In a case of No, the process proceeds to S1407.

In S1407, the mode setting section 76 sets the acceleration limit mode (B) that is relatively loose acceleration restriction. Based on this, the action decision section 77 and the control execution section 64 cause the subject vehicle Am to travel on the connection road CR while slightly accelerating after passing through the first intersection IS1. The series of processes terminates at S1407.

In S1408, the mode setting section 76 sets the acceleration limit mode (A) that is relatively strict acceleration restriction. Based on this, the action decision section 77 and the control execution section 64 cause the subject vehicle Am to travel on the connection road CR substantially at a constant speed without acceleration after passing through the first intersection IS1. The series of processes terminates at S1408.

According to the fourteenth embodiment described above, in a case where the subject vehicle Am is scheduled to make a turn at the first intersection IS1 and to go straight at the second or subsequent intersection IS2, a mode having a different acceleration limit are set according to the length Lr of the connection road CR. For example, strong acceleration is allowed in a case where the length Lr of the connection road CR is greater than or equal to a preset threshold value length, compared with in a case where the length Lr is smaller than the threshold value length. When strong acceleration is allowed in a case where the length Lr of the connection road CR is short, deceleration is required at the time of entry to the second intersection IS2, and acceleration and deceleration are switched in a short time. That is, the behavior of the subject vehicle Am is unstable. On the other hand, in a case where the length Lr of the connection road CR is long, there is a low possibility that the acceleration and the deceleration are switched in a short time even when strong acceleration is allowed, and there is little concern about destabilization of the behavior. Since the acceleration limit is set according to such a difference, comfortable ride can be realized, and the convenience of the occupant is enhanced.

On the other hand, strong acceleration is preferably restricted even in a case of the threshold value length Lr or more, compared with in a case where the subject vehicle Am travels on a simple straight road without an intersection. There is a high possibility of deceleration in a case where the intersection IS2 is present, compared with in a case of a simple straight road without an intersection, which leads to stabilization of the behavior of the subject vehicle Am by the restriction.

In addition, strong acceleration may be restricted in a case where the length Lr of the connection road CR is greater than or equal to a preset threshold value length and an obstacle is confirmed ahead of and behind the subject vehicle Am, compared with a case where no obstacle is confirmed. By suppressing sudden acceleration that is not predicted from obstacles ahead and behind, it is possible to suppress occurrence of turbulence of a traffic flow.

### Fifteenth Embodiment

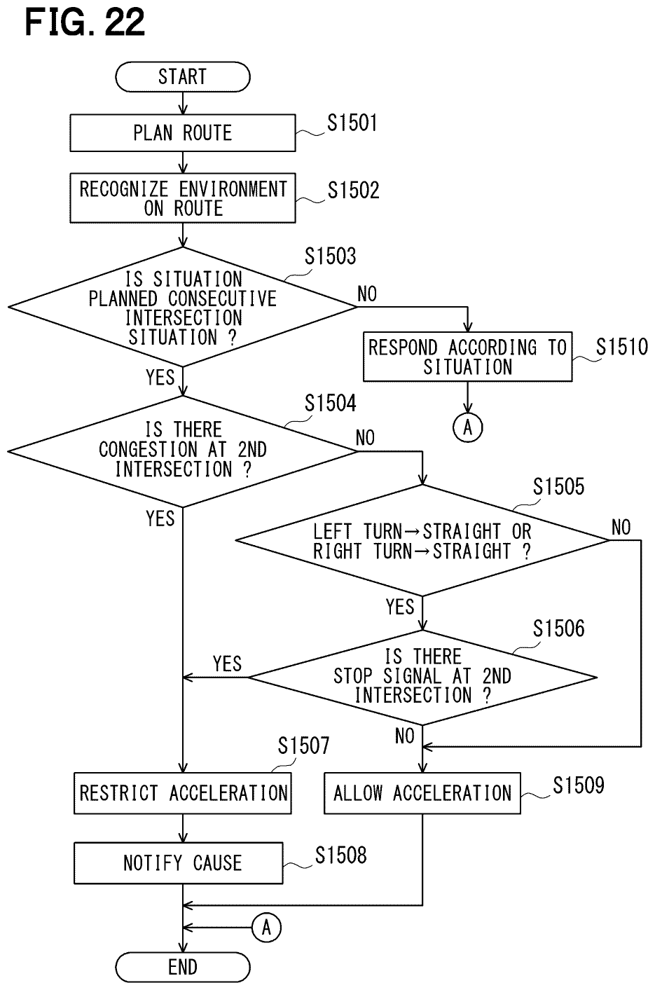

As illustrated in FIG. 22, the fifteenth embodiment is a modification of the fourteenth embodiment. The fifteenth embodiment will be described focusing on differences from the fourteenth embodiment.

In the fifteenth embodiment, the mode setting section 76 decides whether to set the acceleration limit mode according to the environment of the second intersection IS2. In a case where traffic congestion occurs at the second intersection IS2, the mode setting section 76 sets the acceleration limit mode. Further, the mode setting section 76 sets the acceleration limit mode in a case where it is confirmed before the subject vehicle Am enters the first intersection IS1 that the traffic signal TS2 indicates the stop signal at the second intersection IS2. The acceleration limit mode referred to herein may be the acceleration limit mode (A) or the acceleration limit mode (B).

In a case where the acceleration limit mode is set, the mode setting section 76 decides to make a notification indicating the cause of the limitation of the acceleration to the driver. The mode setting section 76 outputs a control command for making the notification to the HMI system 10.

The cause of the limitation of the acceleration is that traffic congestion occurs at the second intersection IS2, the traffic signal TS2 indicates a stop signal at the second intersection IS2, and the like. These causes may be notified by, for example, voice through the speaker 22, may be notified by display through the display device 21, or the speaker 22 and the display device 21 may be used in combination.

Furthermore, in a case where it is possible to indicate the object causing the cause, the display device 21 may perform display for emphasizing the object. The object is, for example, another vehicle causing traffic congestion, a traffic signal indicating a stop signal, or the like.

Next, an example of a processing method by the automated driving ECU 50b will be described with reference to a flowchart of FIG. 22. The process here is executed before the subject vehicle Am enters the first intersection IS1. S1501 to 1503 are similar to S1401 to 1403. In a case of Yes in S1503, the process proceeds to S1504. In a case of No, the process proceeds to S1510. S1510 is similar to S410.

In S1504, the mode setting section 76 determines whether traffic congestion has occurred at the second intersection IS2. In a case of Yes, the process proceeds to S1507. In a case of No, the process proceeds to S1505.

In S1505, the mode setting section 76 determines whether the traveling direction pattern of the subject vehicle Am at the intersections IS1 and IS2 is the pattern (7) or (8). In a case of Yes, the process proceeds to S1506. In a case of No, the process proceeds to S1508.

In S1506, the mode setting section 76 determines whether the traffic signal TS2 indicates a stop signal at the second intersection IS2. In a case of Yes, the process proceeds to S1507. In a case of No, the process proceeds to S1508.

In S1507, the mode setting section 76 restricts acceleration. Based on this, the subject vehicle Am is caused to travel in a state where acceleration is restricted after passing through the first intersection IS1 by the autonomous driving control by the action decision section 77 and the control execution section 64. Furthermore, the notification regarding the cause described above is made. The series of processes terminates at S1507.

In S1508, the mode setting section 76 allows the acceleration without restricting the acceleration. Based on this, the subject vehicle Am accelerates and travels after passing through the first intersection IS1 by the autonomous driving control by the action decision section 77 and the control execution section 64. The series of processes terminates at S1508.

According to the fifteenth embodiment described above, the subject vehicle Am is scheduled to make a turn at the first intersection IS1 and go straight at the second intersection IS2. In this traveling direction pattern, in a case where it is confirmed before the subject vehicle Am enters the first intersection IS1 that the traffic signal TS2 indicates a stop signal at the second intersection IS2, a mode for limiting the acceleration is set. Even when strong acceleration is allowed in a situation where there is a high possibility of deceleration corresponding to the stop signal, acceleration and deceleration are switched in a short time. That is, the behavior of the subject vehicle Am is unstable. Therefore, limiting the acceleration leads to stabilization of the behavior of the subject vehicle Am.

In addition, in this traveling direction pattern, in a case where traffic congestion occurs at the second intersection IS2, a mode for limiting the acceleration is set. Even when strong acceleration is allowed in a situation where there is a high possibility of deceleration corresponding to traffic congestion, acceleration and deceleration are switched in a short time. That is, the behavior of the subject vehicle Am is unstable. Therefore, limiting the acceleration leads to stabilization of the behavior of the subject vehicle Am.

A control command for notifying the driver of the cause of the limitation of the acceleration is output to the HMI system 10. As a result, since the driver can understand the cause of the acceleration, it is possible to reduce the uneasiness of the driver with respect to the autonomous driving control and enhance the feeling of satisfaction.

### Sixteenth Embodiment

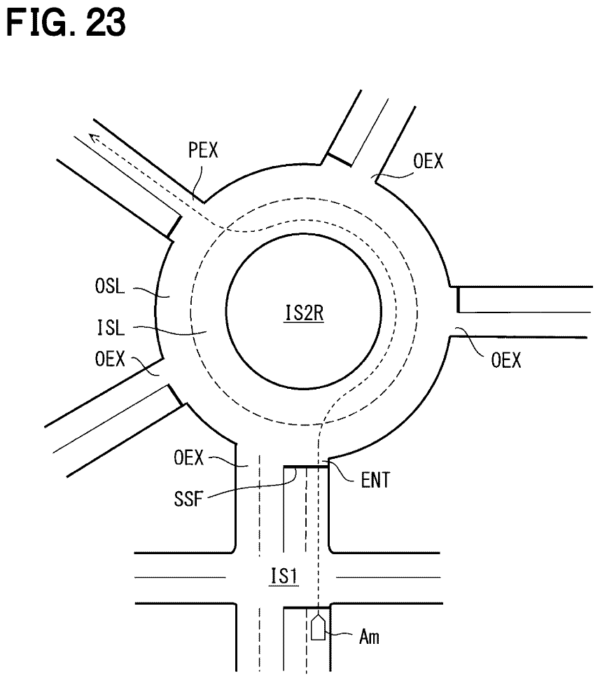

As illustrated in FIGS. 23 to 25, the sixteenth embodiment is a modification of the first embodiment. The sixteenth embodiment will be described focusing on differences from the first embodiment.

In the sixteenth embodiment, the mode setting section 76 determines whether the second or subsequent intersection among the consecutive intersections includes a roundabout, and sets the mode according to the determination result. For example, as illustrated in FIG. 23, in a case where a first intersection among two consecutive intersections is a normal intersection IS1 where the planar intersection occurs at one point, and a second intersection is a roundabout IS2R, vehicle control for the roundabout is set.

The roundabout IS2R has a shape in which a plurality of linear other roads is radially connected to an annular road. The roundabout IS2R may have one lane or a plurality of lanes on an annular road. In a case where a plurality of lanes is provided as illustrated in FIG. 23, the roundabout IS2R has an outer lane OSL and an inner lane ISL in parallel with each other. The outer lane OSL is an annular lane connected to other roads via an entrance ENT and exits PEX and OEX. The inner lane ISL is an annular lane disposed radially inside the outer lane OSL. Normally, the lane change is possible between the outer lane OSL and the inner lane ISL over the entire circumference. The roundabout IS2R has a more complicated structure than a normal intersection, and has a higher difficulty level in autonomous driving control. Since the roundabout IS2R requires two right and left turns, a difficulty level of passing through substantially two intersections may be required. Therefore, the mode setting section 76 sets the strict speed limit in a case where the second or subsequent intersection includes the roundabout IS2R. The speed limit here may be more severe than the speed limit in a case where two normal intersections are continuous. The speed limit here may be as strict as the speed limit in a case where the traffic signal indicates a stop signal at an intersection where the traffic signal includes the stop signal.

Further, the mode setting section 76 may change the allowable acceleration in the operation of entering the roundabout IS2R according to the scale of the roundabout IS2R. The mode setting section 76 may allow a larger acceleration as the scale increases. This is because, in the large-scale roundabout IS2R, a route from entry from the entrance ENT to exit from the exits PEX and OEX tends to be long, and the subject vehicle Am can be made to travel at a certain speed in the route.

The entry operation here may include, for example, an acceleration operation for merging into the outer lane OSL or the inner lane ISL after stopping at a stop line present near the entrance ENT. The scale of the roundabout IS2R may be defined by, for example, the number of lanes in the roundabout IS2R or the radius of the roundabout IS2R, or a combination thereof. For example, the scale threshold value may be set to two lanes, and a roundabout IS2R of two or more lanes may be classified into a large roundabout, and a roundabout IS2R of one lane may be classified into a small roundabout.

Further, during traveling in the roundabout IS2R of the subject vehicle Am, the mode setting section 76 or the action decision section 77 determines whether a situation in which the exit from the exit PEX scheduled as the planned route cannot be made has continued for a predetermined time or more. In addition, the mode setting section 76 or the action decision section 77 determines whether it is difficult to continue the autonomous driving control for exiting from the exit PEX scheduled as the planned route.

In a case where these conditions are satisfied, the mode setting section 76 or the action decision section 77 switches the current autonomous driving control to the emergency control. The emergency control may be, for example, control of giving up exiting from the exit PEX and exiting from another exit OEX (for example, the closest exit from which the vehicle is allowed to exit) that the vehicle is allowed to exit. The emergency control may be control of continuing a state in which the subject vehicle Am annularly travels in the roundabout IS2R. In a case where the state in which the vehicle annularly travels is continued, the subject vehicle Am annularly travels in the outer lane OSL or the inner lane ISL and waits for the driving-mode switch until the driver voluntarily executes the driving-mode switch.

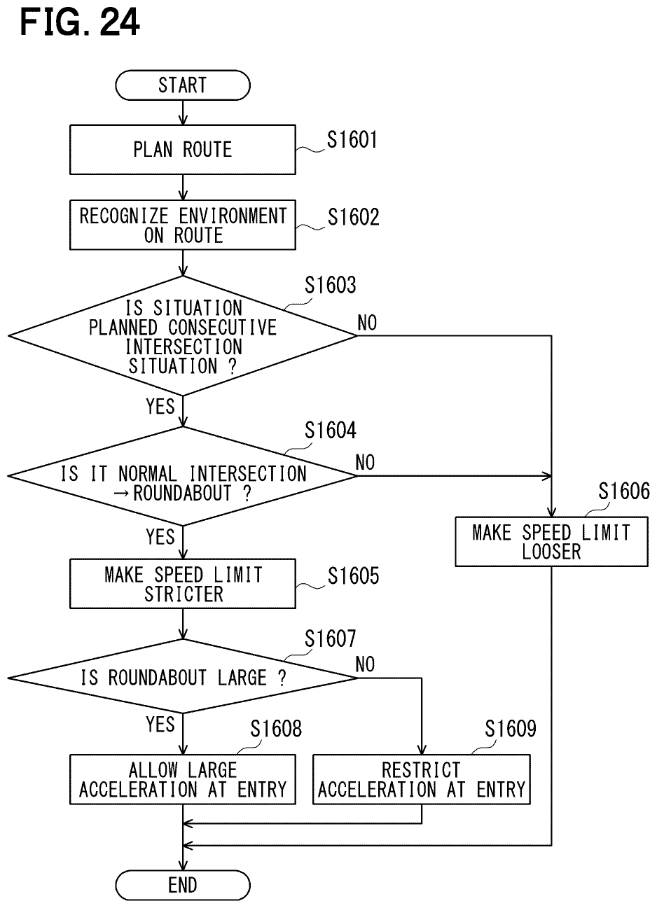

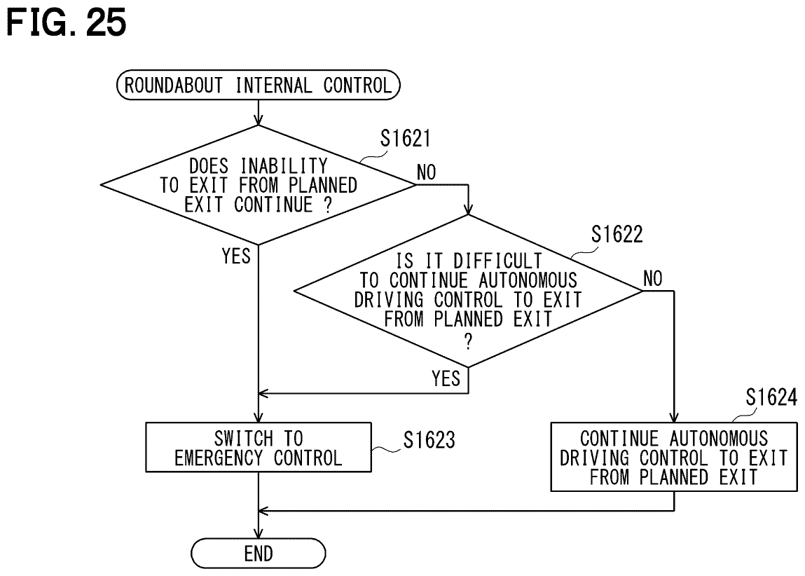

Next, an example of a processing method by the automated driving ECU 50b will be described with reference to flowcharts of FIGS. 24 and 25. It is assumed that the process of FIG. 24 is executed before the subject vehicle Am enters the first intersection IS1. S1601 to 1603 are similar to S101 to 103. In a case of Yes in S1603, the process proceeds to S1604. In a case of No, the process proceeds to S1606.

In S1604, the mode setting section 76 determines whether the first intersection is a normal intersection, and the roundabout is included in the second or subsequent intersection. In a case of Yes, the process proceeds to S1605. In a case of No, the process proceeds to S1606.

In S1605 in a case where the roundabout IS2R is included, the mode setting section 76 tightens the speed limit of the subject vehicle Am in the consecutive intersections passage. That is, the maximum speed (for example, 20 km/h) smaller than that in a case of S1606 is set. After the process of S1605, the process proceeds to S1607.

In S1606 in a case where the roundabout IS2R is not included, the mode setting section 76 loosens the speed limit of the subject vehicle Am in the consecutive intersections passage. That is, the maximum speed (for example, 30 km/h) larger than that in a case of S1605 is set. The series of processes terminates at S1606.

In S1607, the mode setting section 76 determines whether the scale of the roundabout IS2R is larger than a preset scale threshold value. In a case of Yes, the process proceeds to S1608. In a case of No, the process proceeds to S1609.

In S1608, the mode setting section 76 allows a large acceleration at the time of entry. For example, the maximum acceleration larger than that in a case of S1609 is set. The series of processes terminates at S1608.

In S1609, the mode setting section 76 restricts the acceleration at the time of entry. For example, the maximum acceleration smaller than that in a case of S1608 is set. The series of processes terminates at S1608.

Next, it is assumed that the process of FIG. 25 is executed while the subject vehicle Am is traveling in the outer lane OSL or the inner lane ISL after entering the roundabout IS2R. In first S1621, the mode setting section 76 or the action decision section 77 determines whether a situation in which the vehicle is not allowed to exit from the scheduled exit PEX has continued for a predetermined time or more. In a case of Yes, the process proceeds to S1623. In a case of No, the process proceeds to S1622.

In S1622, the mode setting section 76 or the action decision section 77 determines whether it is difficult to continue the autonomous driving control for exiting from the scheduled exit PEX. In a case of Yes, the process proceeds to S1623. In a case of No, the process proceeds to S1624.

In S1623 In a case of Yes in S1621 or S1622, the mode setting section 76 or the action decision section 77 switches the control of the subject vehicle Am to the above-described emergency control. The series of processes terminates at S1623.

In S1624 in a case of No in either S1621 or S1622, the mode setting section 76 or the action decision section 77 continues the autonomous driving control of exiting from the scheduled exit PEX. The series of processes terminates at S1624.

According to the sixteenth embodiment described above, the speed limit is set more strictly in a case where the second or subsequent intersection among the plurality of consecutive intersections includes the roundabout IS2R than in a case where the second or subsequent intersection does not include the roundabout IS2R. Therefore, even in a case where the subject vehicle Am passes through the roundabout IS2R having a complex structure, it is easy to continue the autonomous driving control.

Further, according to the sixteenth embodiment, in a case where the second or subsequent intersection among the plurality of consecutive intersections includes the roundabout IS2R, the allowable acceleration in the operation of entering the roundabout IS2R is changed according to the scale of the roundabout IS2R. Accordingly, it is possible to smoothly perform automated driving control of the roundabout IS2R.

Further, according to the sixteenth embodiment, in a case where a plurality of consecutive intersections includes the roundabout IS2R and a situation where the vehicle is not allowed to exit from the scheduled exit PEX in the roundabout IS2R continues for a predetermined time or more, the subject vehicle Am is caused to exit from another exit OEX from which the vehicle is allowed to exit. By doing so, the deadlock state in the autonomous driving control can be resolved.

In addition, according to the sixteenth embodiment, in a case where a plurality of consecutive intersections includes the roundabout IS2R, and it is difficult to continue the autonomous driving control for exiting from the scheduled exit PEX in the roundabout IS2R, the subject vehicle Am is caused to continue the state of traveling annularly in the roundabout IS2R. By giving up the scheduled escape from the exit PEX, it is possible to avoid the problem of occurrence of an accident due to forced escape.

Further, according to the sixteenth embodiment, in a case where a plurality of consecutive intersections includes the roundabout IS2R and it is difficult to continue the autonomous driving control for exiting from the scheduled exit PEX in the roundabout IS2R, the subject vehicle Am is caused to exit from another exit OEX from which the subject vehicle Am is allowed to exit. By doing so, the deadlock state in the autonomous driving control can be resolved.

Further, according to the sixteenth embodiment, in a case where a plurality of consecutive intersections includes the roundabout IS2R and a situation where the vehicle is not allowed to exit from the scheduled exit PEX in the roundabout IS2R continues for a predetermined time or more, the subject vehicle Am continues to annularly travel in the roundabout IS2R. By giving up the scheduled escape from the exit PEX, it is possible to avoid the problem of occurrence of an accident due to forced escape.

### Seventeenth Embodiment

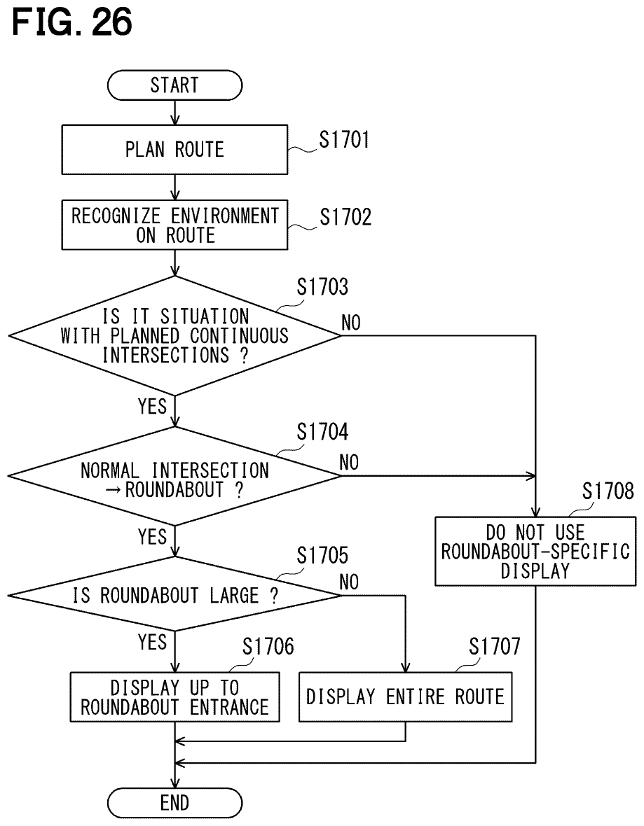

As illustrated in FIG. 26, the seventeenth embodiment is a modification of the sixteenth embodiment. The seventeenth embodiment will be described focusing on differences from the sixteenth embodiment.

In the seventeenth embodiment, the mode setting section 76 outputs a control command for executing a roundabout display by the display device 21 to the HMI system 10 in combination with the autonomous driving control of the sixteenth embodiment. Further, the mode setting section 76 changes the content of the roundabout display according to the scale of the roundabout IS2R.

Specifically, in a case where the second intersection is a large-scale roundabout, the mode setting section 76 causes the display device 21 to display a route from the current position of the subject vehicle Am to the entrance ENT of the roundabout IS2R in the form of, for example, a bird's-eye view map. In other words, the roundabout IS2R including the entrance ENT is only partially displayed, and is not entirely displayed. The route in the roundabout IS2R is not displayed.

On the other hand, in a case where the second intersection is a small-scale roundabout, the mode setting section 76 causes the display device 21 to display a route from the current position of the subject vehicle Am to the exit PEX of the roundabout IS2R in the form of, for example, a bird's-eye view map. In other words, the entire roundabout IS2R is displayed.

Next, an example of a processing method by the automated driving ECU 50b will be described with reference to a flowchart of FIG. 26. The process here is executed before the subject vehicle Am enters the first intersection IS1.

S1701 to 1704 are similar to S1601 to 1604. In a case where the process of S1601 to 1609 and the process of S1701 to 1707 are executed in parallel, the process of S1701 to S1704 do not need to be executed separately from the process of S1601 to S1604, and the process of S1601 to 1609 may be used. In a case of Yes in S1704, the process proceeds to S1705. In a case of No in S1703 and in a case of No in S1704, the process proceeds to S1708.

The process of S1705 is similar to the process of S1607. Therefore, it is possible to use the same. In a case of Yes in S1705, the process proceeds to S1706. In a case of No, the process proceeds to S1707.

In S1706, the mode setting section 76 outputs a control command to the HMI system 10 so that the display device 21 displays the route from the current position of the subject vehicle Am to the entrance ENT of the roundabout IS2R. The series of processes terminates at S1706.

In S1707, the mode setting section 76 outputs a control command to the HMI system 10 so that the display device 21 displays the route from the current position of the subject vehicle Am to the exit PEX of the roundabout IS2R. The series of processes terminates at S1707.

According to the seventeenth embodiment described above, in a case where the plurality of consecutive intersections is two consecutive intersections and the second intersection is the roundabout IS2R, the content to be displayed on the display device 21 is changed according to the scale of the roundabout IS2R. Therefore, it is possible to realize display that is easily recognized by the occupant.

According to the seventeenth embodiment, in a case where the scale of the roundabout IS2R is equal to or larger than the threshold value scale, the display device 21 displays the route to the entrance ENT of the roundabout IS2R before the subject vehicle Am enters the first intersection IS1. By reducing the complexity of the displayed route, it is possible to realize display that is easily recognized by the occupant.

Further, according to the seventeenth embodiment, in a case where the scale of the roundabout IS2R is smaller than the threshold value scale, the display device 21 displays the route of the entire plurality of consecutive intersections before the subject vehicle Am enters the first intersection IS1. In a case where the complexity is relatively small, display is performed so that the entire roundabout IS2R can be recognized, whereby the occupant can easily grasp the destination of the subject vehicle Am.

### Eighteenth Embodiment

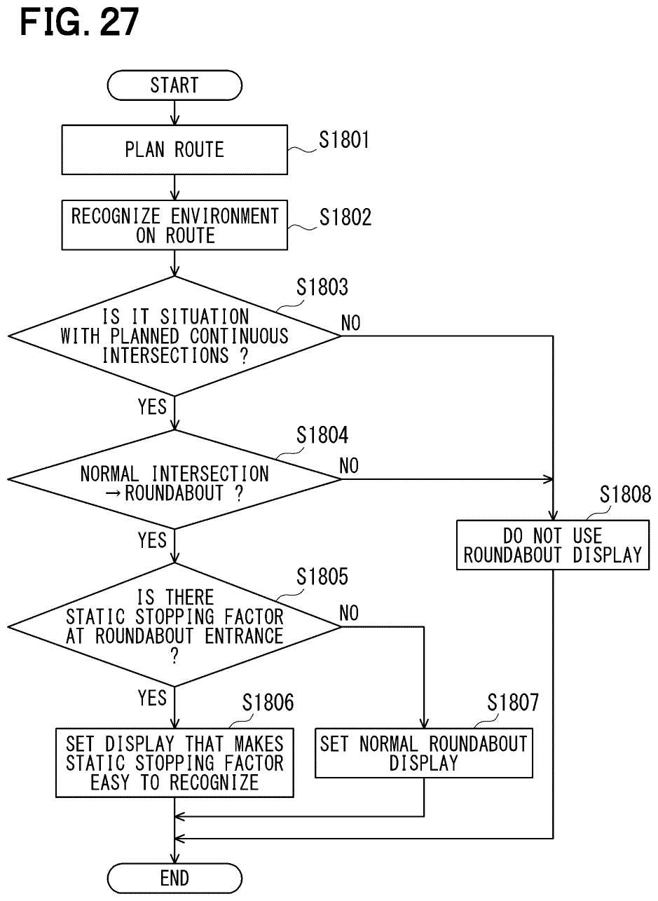

As illustrated in FIG. 27, the eighteenth embodiment is a modification of the seventeenth embodiment. The eighteenth embodiment will be described focusing on differences from the seventeenth embodiment.

In the eighteenth embodiment, the mode setting section 76 outputs a control command for executing a roundabout display by the display device 21 to the HMI system 10 in combination with the autonomous driving control of the sixteenth embodiment. Further, the mode setting section 76 changes the content of the roundabout display according to the presence or absence of a static stop factor SFF at the entrance ENT of the roundabout IS2R.

The static stop factor SFF is, for example, a factor that may cause the subject vehicle Am to have to stop, such as a static road mark. The static stop factor SFF may be a stop line present in front of the outer lane OSL or a crosswalk present in front of the outer lane OSL.

In a case where there is such a static stop factor SFF, the mode setting section 76 changes the display content so that the static stop factor SFF is easily recognized. In a case where the display indicating the route is in the form of a bird's-eye view map, the angle and the scale factor are adjusted. When the static stop factor SFF such as a crosswalk is displayed at a small depression angle, it is difficult to grasp the position of the static stop factor SFF, so that a large depression angle such as substantially vertical is selected. In addition, in order to facilitate recognition of the static stop factor SFF and its surroundings, display in which the static stop factor SFF is located at the screen end of the display device 21 is avoided.

Next, an example of a processing method by the automated driving ECU 50b will be described with reference to a flowchart of FIG. 27. The process here is executed before the subject vehicle Am enters the first intersection IS1. S1801 to 1804 are similar to S1801 to 1804. In a case of Yes in S1804, the process proceeds to S1805. In a case of No in S1803 and in a case of No in S1804, the process proceeds to S1808.

In S1805, the mode setting section 76 determines whether there is the static stop factor SFF in the entrance ENT of the roundabout IS2R. In a case of Yes, the process proceeds to S1806. In a case of No, the process proceeds to S1807.

In S1806, the mode setting section 76 outputs a control command to the HMI system 10 so that the display device 21 performs display that is easily recognized by the static stop factor SFF as described above. The series of processes terminates at S1806.

In S1807, the mode setting section 76 outputs a control command to the HMI system 10 so that the display device 21 performs the normal roundabout display. The normal roundabout display may be a display set in S1705 to 1707. The series of processes terminates at S1807. S1808 is similar to S1708.

According to the eighteenth embodiment described above, in a case where a plurality of consecutive intersections is two consecutive intersections and the second intersection is the roundabout IS2R, the content to be displayed on the display device 21 is changed according to the presence or absence of the static stop factor SFF in the entrance ENT of the roundabout IS2R. This makes it easier for the occupant to recognize the static stop factor SFF.

### Nineteenth Embodiment

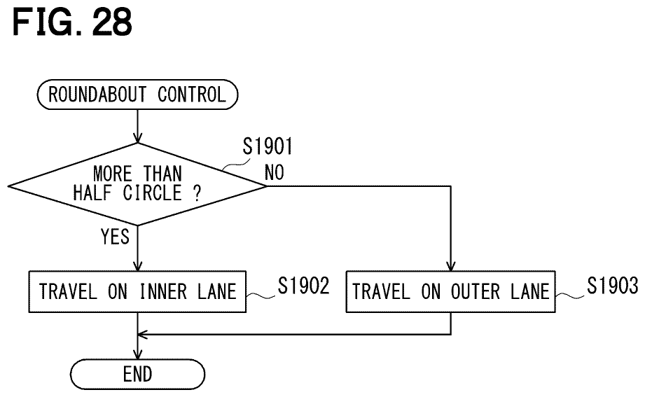

As illustrated in FIG. 28, the nineteenth embodiment is a modification of the sixteenth embodiment. The nineteenth embodiment will be described focusing on differences from the sixteenth embodiment.

In the nineteenth embodiment, it is assumed that the roundabout IS2R has a plurality of lanes. In such control of the roundabout IS2R, the mode setting section 76 or the action decision section 77 decides in which lane among the plurality of lanes the subject vehicle Am is caused to travel according to, for example, the turning angle.

As an example, the inner lane ISL may be selected in a case where the turning angle is 180 degrees or more (half turn or more), and the outer lane OSL may be selected in a case where the turning angle is smaller than 180 degrees. As another example, in a case where the turning angle is less than or equal to the angle from the entrance ENT to the first turning exit, that is, the first exit is the exit PEX from which the vehicle is scheduled to exit, the outer lane OSL may be selected, and in a case where the angle is greater than the angle to the first exit, that is, the second or subsequent exit is the exit PEX from which the vehicle is scheduled to exit, the inner lane ISL may be selected.

Next, an example of a processing method by the automated driving ECU 50b will be described with reference to a flowchart of FIG. 28. It is assumed that the process is executed before the subject vehicle Am enters the roundabout IS2R. In S1901, the mode setting section 76 or the action decision section 77 determines whether the subject vehicle Am is scheduled to turn by half turn or more in the roundabout IS2R. In a case of Yes, the process proceeds to S1902. In a case of No, the process proceeds to S1903.

In S1902, the mode setting section 76 or the action decision section 77 decides to cause the subject vehicle Am to travel in the inner lane ISL. In S1903, the mode setting section 76 or the action decision section 77 decides to cause the subject vehicle Am to travel in the outer lane OSL. A series of processes terminates at S1902 and 1903.

According to the nineteenth embodiment described above, in a case where a plurality of consecutive intersections includes the roundabout IS2R having a plurality of lanes, which lane of the plurality of lanes the vehicle travels around at is decided according to the turning angle from the entrance ENT of the roundabout IS2R to the scheduled exit PEX. Therefore, it is possible to appropriately perform autonomous driving control of the subject vehicle Am in the roundabout IS2R.

### Twentieth Embodiment

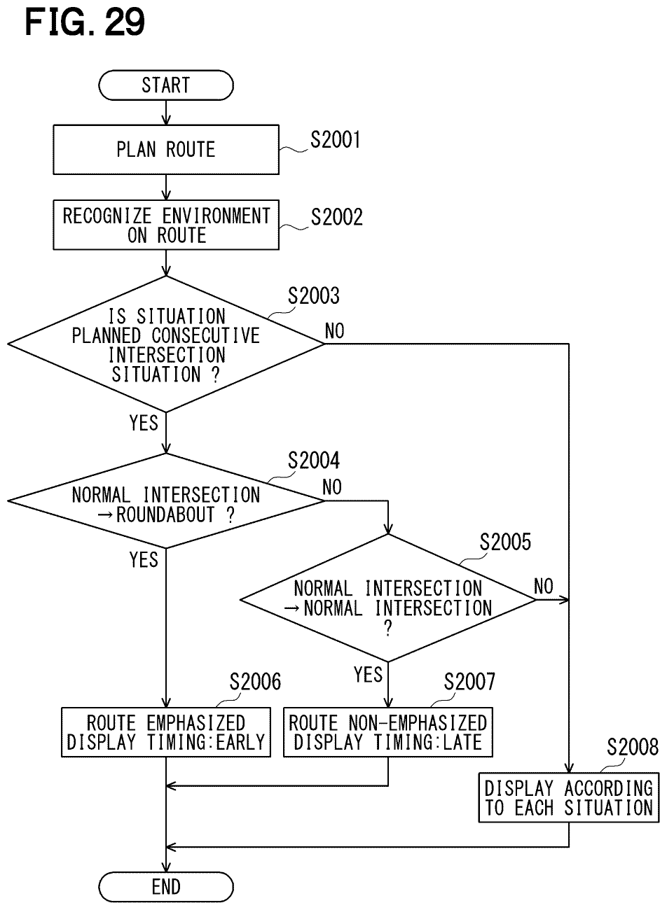

As illustrated in FIG. 29, the twentieth embodiment is a modification of the seventeenth embodiment. The twentieth embodiment will be described focusing on differences from the seventeenth embodiment.

In the twentieth embodiment, the mode setting section 76 outputs a control command for executing display by the display device 21 to the HMI system 10 so as to change the aspect of route display according to the type of consecutive intersections. The route display is, for example, content in which a scheduled travel route of the subject vehicle Am is displayed by, for example, an arrow. The mode setting section 76 makes the degree of emphasis and the display start timing of the route display displayed in the form of the bird's-eye view map different in accordance with the types of consecutive intersections.

For example, the route display is more highlighted and the display start timing is made earlier in a case where the first intersection is the normal intersection IS1 and the second intersection is the roundabout IS2R than in a case where both intersections are the normal intersections IS1 and IS2.

The highlighting of the route display can be realized by, for example, highlighting processing such as thickening or greatly blinking an arrow indicating the route. The display start timing may be set when the subject vehicle Am reaches 500 m before the intersection IS1 in a case where the first intersection is normal intersection IS1 and the second intersection is the roundabout IS2R, and may be set when the subject vehicle Am reaches 300 m before the intersection IS1 in a case where both intersections are normal intersections IS1, and IS2. The numerical value here may be changed as appropriate.

Next, an example of a processing method by the automated driving ECU 50b will be described with reference to a flowchart of FIG. 29. The process here is executed before the subject vehicle Am enters the first intersection IS1. S2001 to 2004 are similar to S1701 to 1704. In a case of No in S2003, the process proceeds to S2008. In a case of Yes in S2004, the process proceeds to S2006. In a case of No in S2004, the process proceeds to S2005.

In S2005, the mode setting section 76 determines whether both the first intersection and the second intersection are normal intersections. In a case of Yes, the process proceeds to S2007. In a case of No, the process proceeds to S2008.

In S2006, the mode setting section 76 outputs a control command for executing display by the display device 21 to the HMI system 10 so that the display highlighting the route is started earlier than the timing in S2007. The series of processes terminates at S2006.

In S2007, the mode setting section 76 outputs a control command for executing display by the display device 21 to the HMI system 10 so that the display that does not highlight the route is started later than the timing in S2006. The series of processes terminates at S2007.

In S2008, the mode setting section 76 outputs a control command for executing display by the display device 21 to the HMI system 10 so as to realize display corresponding to each situation. The series of processes terminates at S2008.

According to the twentieth embodiment described above, in a case where a plurality of consecutive intersections is two consecutive intersections, the first intersection is the normal intersection IS1, and the second intersection is the roundabout IS2R, it is determined to make a notification that emphasizes the route, compared with in a case where both intersections are normal intersections. Therefore, in a case where a complex structure is included in consecutive intersections, the occupant can easily recognize the route.

In addition, according to the twentieth embodiment, in a case where a plurality of consecutive intersections is two consecutive intersections, the first intersection is the normal intersection IS1, and the second intersection is the roundabout IS2R, it is determined to make a notification about the route at a timing earlier than a timing in a case where both intersections are normal intersections. Therefore, in a case where a complex structure is included in consecutive intersections, the occupant can easily recognize the route.

### Twenty-First Embodiment

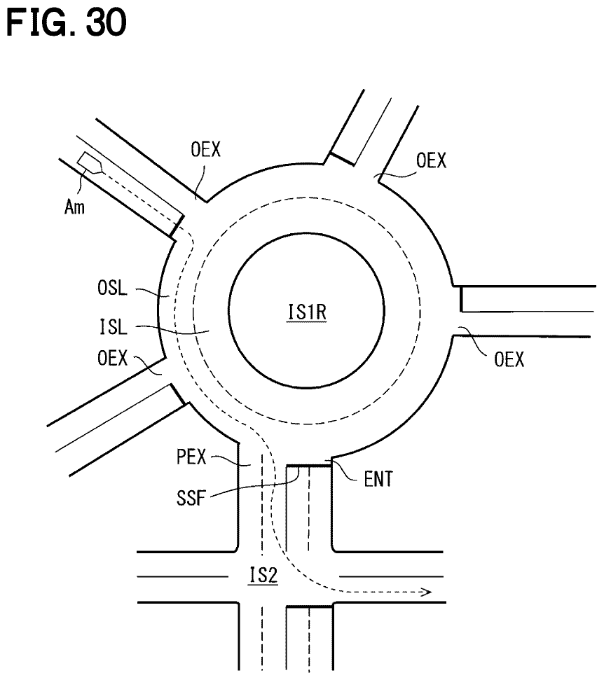

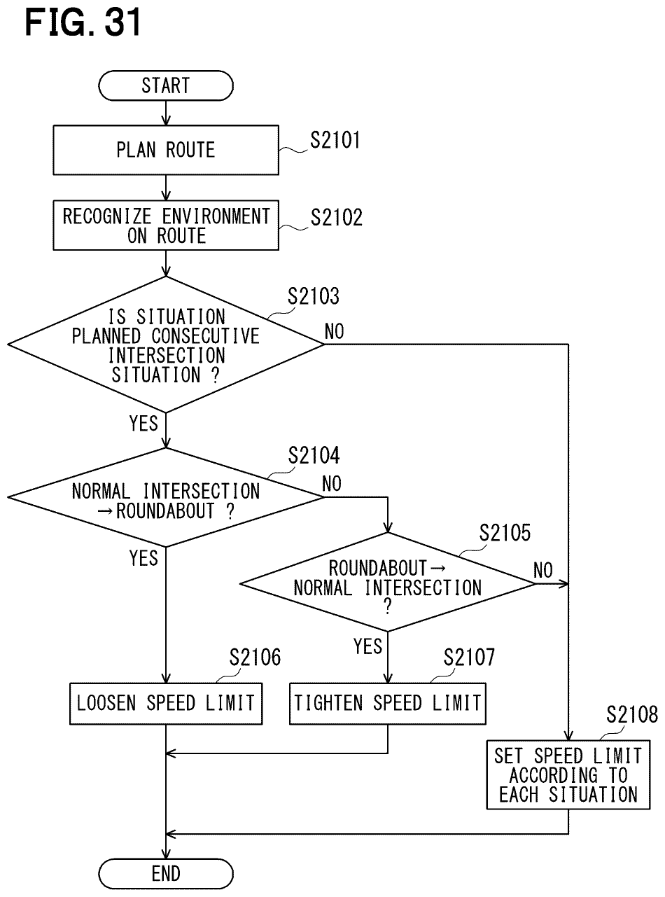

As illustrated in FIGS. 30 and 31, the twenty-first embodiment is a modification of the sixteenth embodiment. The twenty-first embodiment will be described focusing on differences from the sixteenth embodiment.

In the sixteenth embodiment, the mode setting section 76 sets a mode having a different speed limit according to the order of passing through the roundabout at a plurality of consecutive intersections. For example, in a case where two intersections are continuous, a mode having a different speed limit is set depending on whether the roundabout is the first intersection or the second intersection.

Specifically, the speed limit is set more strictly in a case where the first intersection is the roundabout IS1R as illustrated in FIG. 30 than in a case where the second intersection is the roundabout as illustrated in FIG. 23. For example, the maximum speed may be 15 km/h in a case where the first intersection is the roundabout IS1R, the maximum speed may be 20 km/h in a case where the second intersection is the roundabout IS2R, and the maximum speed may be 25 km/h in a case where the two intersections do not include the roundabout.

In addition, in a case where the first intersection is the roundabout IS1R and the second intersection is the normal intersection IS2, the action decision section 77 may decelerate the subject vehicle Am immediately before exiting from the scheduled exit PEX in the roundabout IS1R. Conversely, since a constant low speed in the roundabout IS2R may disturb the traffic flow, the speed limit may be exceptionally loosened or disabled in a case where the vehicle travels annularly in the lanes OSL and ISL in the roundabout IS2R.

Next, an example of a processing method by the automated driving ECU 50b will be described with reference to a flowchart of FIG. 31. The process here is executed before the subject vehicle Am enters the first intersection IS1. S2101 to 2104 are similar to S1601 to 1604. In a case of No in S2103, the process proceeds to S2108. In a case of Yes in S2104, the process proceeds to S2106. In a case of No in S2104, the process proceeds to S2105.

In S2105, the mode setting section 76 determines whether the first intersection is the roundabout IS1R. In a case of Yes, the process proceeds to S2107. In a case of No, the process proceeds to S2108.

In S2106, the mode setting section 76 sets a speed limit that is looser than that in a case of S2107. In S2107, the mode setting section 76 sets the speed limit that is stricter than that in a case of S2106. A series of processes terminates at S2106 and 2107.

In S2108, the mode setting section 76 may set the speed limit corresponding to each of the other situations. The series of processes terminates at S2108.

According to the twenty-first embodiment described above, in a case where a plurality of consecutive intersections includes the roundabout IS1R and IS2R, a mode having a different speed limit is set according to the order of passing through the roundabout at the plurality of consecutive intersections. According to the mode optimized according to the driving control difficulty level, the subject vehicle Am can pass through a plurality of consecutive intersections. Therefore, the occupant who uses the autonomous driving control can enjoy high convenience.

Further, according to the twenty-first embodiment, a strict speed limit is set in a case where a plurality of consecutive intersections is two consecutive intersections and the first intersection is the roundabout IS1R, compared with a case where the second intersection is the roundabout IS2R. Therefore, it is possible to proceed to the second intersection while reducing the risk.

Further, according to the twenty-first embodiment, in a case where the subject vehicle Am is scheduled to pass through the normal intersection IS2 after passing through the roundabout IS1R, the subject vehicle Am is decelerated immediately before exiting from the scheduled exit PEX in the roundabout IS1R. Therefore, it is possible to reduce the risk and proceed to the second intersection while preventing the traffic flow in the roundabout IS1R from being disturbed as much as possible.

### Twenty-Second Embodiment

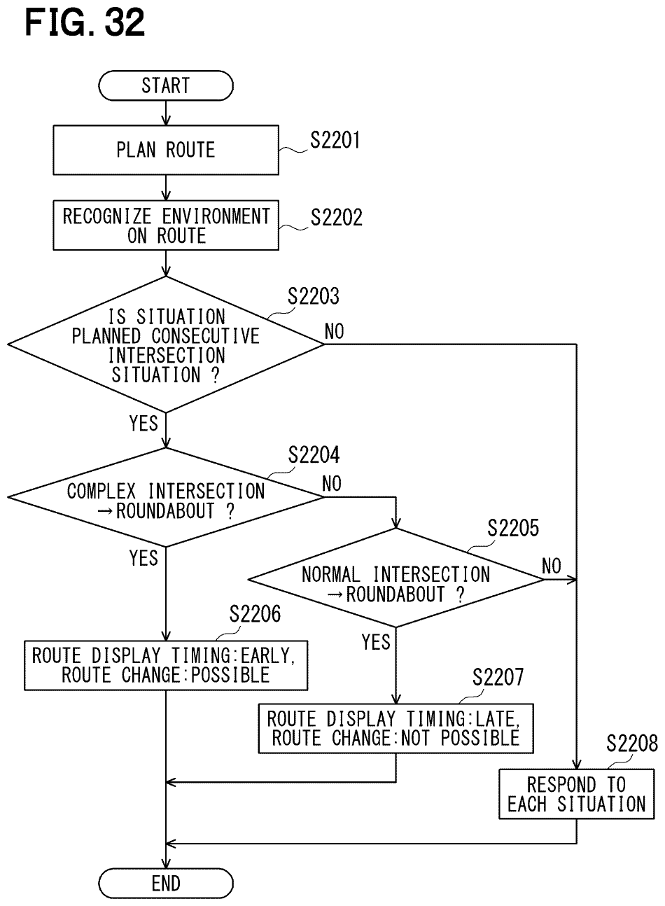

As illustrated in FIG. 32, the twenty-second embodiment is a modification of the twenty-first embodiment. The twenty-first embodiment will be described focusing on differences from the twenty-first embodiment.

In the twenty-second embodiment, the mode setting section 76 outputs a control command for executing a roundabout display by the display device 21 to the HMI system 10 in combination with the autonomous driving control of the twenty-first embodiment.

Specifically, the mode setting section 76 determines whether two consecutive intersections are a roundabout and a combination of a complex intersection other than the roundabout and the roundabout. Here, the complex intersection may be an intersection of five or more way intersection excluding a three-way intersection and a four-way intersection. The complex intersection may be a large-scale intersection to which roads of four or more lanes are connected, or may be an intersection including a unique special lane.

In a case where the first intersection is a complex intersection and the second intersection is the roundabout IS2R, the mode setting section 76 decides to make a notification about the route at a timing earlier than a timing in a case where the first intersection is an intersection having a simple structure. The notification about the route may be route display on the display device 21 or audio notification by the speaker 22. The notification start timing may be set when the subject vehicle Am reaches 500 m before the intersection IS1 in a case where the first intersection is normal intersection IS1, and may be set when the subject vehicle Am reaches 600 m before the first intersection in a case where the first intersection is a complex intersection. The numerical value here may be changed as appropriate.

In addition, the mode setting section 76 normally prohibits the route change in the autonomous driving control by the input operation by the driver using the operation device 26. However, when two consecutive intersections are a roundabout and a combination of a complex intersection other than the roundabout and the roundabout, the time taken for the subject vehicle Am to pass through the plurality of consecutive intersections is longer. Therefore, in a case where the first intersection is a complex intersection and the second intersection is the roundabout IS2R, the mode setting section 76 may exceptionally permit the route change while the subject vehicle Am passes through a plurality of consecutive intersections.

The exceptional permission for the route change may be executed in a case where the mode setting section 76 predicts the time taken for which the subject vehicle Am passes through a plurality of consecutive intersections and the predicted time is equal to or longer than a threshold value time, instead of making determination by the type of intersection. The threshold value time may be appropriately set, for example, 1 minute or more, 3 minutes or more, or the like.

Next, an example of a processing method by the automated driving ECU 50b will be described with reference to a flowchart of FIG. 32. The process here is executed before the subject vehicle Am enters the first intersection IS1. S2201 to 2203 are similar to S2101 to 2103. In a case of Yes in S2103, the process proceeds to S2204. In a case of No, the process proceeds to S2208.

In S2204, the mode setting section 76 determines whether a first intersection is a complex intersection and a second intersection is the roundabout IS2R among two consecutive intersections. In a case of Yes, the process proceeds to S2206. In a case of No, the process proceeds to S2205.

In S2205, the mode setting section 76 determines whether the first intersection is the normal intersection IS1 and the second intersection is the roundabout IS2R among two consecutive intersections. In a case of Yes, the process proceeds to S2207. In a case of No, the process proceeds to S2208.

In S2206 in a case where the first intersection is a complex intersection, the mode setting section 76 sets the route display timing earlier than in S2207 and permits the route change. In S2207 in a case where the first intersection is a normal intersection, the mode setting section 76 sets the route display timing later than in S2206 and prohibits the route change. A series of processes terminates at S2206 and 2207.

In S2208, the mode setting section 76 may execute mode setting corresponding to each of the other situations. The series of processes terminates at S2208.

According to the twenty-second embodiment described above, in a case where a plurality of consecutive intersections is two consecutive intersections, the second intersection is the roundabout IS2R, and the first intersection is an intersection having a complex structure other than the roundabout, the notification about the route is made at a timing earlier than a timing in a case where the first intersection is an intersection having a simple structure. Therefore, it is easy for the driver to recognize that the driving control difficulty level of the autonomous driving is high at an early stage and to prepare for the possibility of executing the driving-mode switch.

According to the twenty-second embodiment, in a case where a plurality of consecutive intersections is two consecutive intersections, the second intersection is the roundabout IS2R, and the first intersection is an intersection having a complex structure other than the roundabout, the route change in the autonomous driving control by the input operation by the driver using the operation device 26 is permitted while the subject vehicle Am passes through the plurality of consecutive intersections. Therefore, a situation in which the route cannot be changed for a long time is avoided, and convenience is enhanced.

Further, according to the twenty-second embodiment, in a case where it is predicted that the time taken for which the subject vehicle Am passes through a plurality of consecutive intersections is equal to or longer than the threshold value time, the route change in the autonomous driving control by the input operation by the driver using the operation device 26 is permitted. Therefore, a situation in which the route cannot be changed for a long time is avoided, and convenience is enhanced.

### Twenty-Third Embodiment

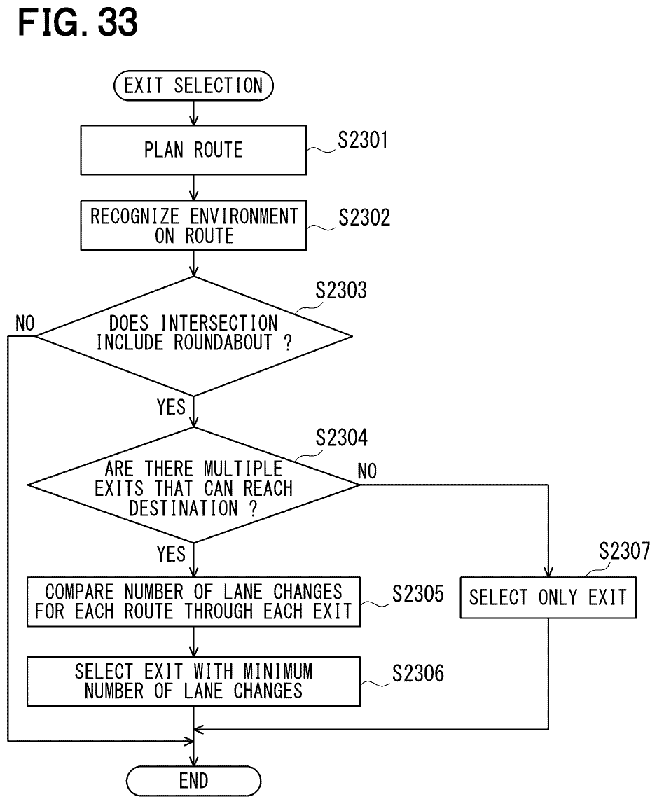

As illustrated in FIG. 33, the twenty-third embodiment is a modification of the sixteenth embodiment. The twenty-third embodiment will be described focusing on differences from the sixteenth embodiment.

In the twenty-third embodiment, the environment recognition section 62 identifies a situation in which the intersection includes the roundabout IS2R, IS2R, and the vehicle is allowed to arrive at the destination even when the vehicle travels through any of two or more exits among the plurality of exits PEX and OEX of the roundabout. The route planning section 75 selects the exit PEX from which the vehicle is allowed to arrive at the destination with the smallest number of times of lane change among the exits PEX and OEX from which the vehicle is allowed to arrive at the destination.

In a case where the roundabout has a plurality of lanes OSL, and ISL, the number of times of lane change here may in particular be the number of times of lane change within the roundabout.

Next, an example of a processing method by the automated driving ECU 50b will be described with reference to a flowchart of FIG. 33. The process here is a process specialized for exit selection of the roundabout performed before the subject vehicle Am enters the roundabout IS1R, IS2R. S2301 to 2302 are similar to S1601 to 1602. After the process of S2302, the process proceeds to S2303.

In S2303, the environment recognition section 62 determines whether the intersection includes the roundabout IS2R. In a case of Yes, the process proceeds to S2303. In a case of No, the series of processes terminates.

In S2304, the environment recognition section 62 determines whether there is a plurality of exits PEX and OEX from which the vehicle is allowed to arrive at the destination. In a case of Yes, the process proceeds to S2305. In a case of No, the process proceeds to S2307.

In S2305, the route planning section 75 compares the number of times of lane change in each route passing through the exits PEX and OEX from which the vehicle is allowed to arrive at the destination. In S2306 after the process of S2305, the route planning section 75 selects the exit PEX that minimizes the number of times of lane change. The series of processes terminates at S2306.

On the other hand, in S2307, the route planning section 75 selects the only exit PEX from which the vehicle is allowed to arrive at the destination. The series of processes terminates at S2307.

According to the twenty-third embodiment described above, the situation in which the plurality of consecutive intersections includes the roundabout IS1R, IS2R, and the vehicle is allowed to arrive at the destination even when the vehicle travels through any of the two or more exits of the plurality of exits PEX and OEX of the roundabout IS1R, IS2R is identified. Further, among the exits from which the vehicle is allowed to arrive at the destination, the exit PEX from which the vehicle is allowed to arrive at the destination with the smallest number of times of lane change is selected. In this way, the risk in the lane change can be reduced.

Further, according to the twenty-third embodiment, in a case where the roundabout IS1R, IS has a plurality of lanes, the exit PEX from which the vehicle is allowed to arrive at the destination with the smallest number of times of lane change in the roundabout IS1R, IS2R is selected among the exits from which the vehicle is allowed to arrive at the destination. In this way, the risk in the lane change in the roundabout IS1R, IS2R can be reduced.

### OTHER EMBODIMENTS

Although a plurality of embodiments has been described above, the present disclosure is not to be construed as being limited to these embodiments, and can be applied to various embodiments and combinations without departing from the gist of the present disclosure.

For example, in the thirteenth embodiment, in a case where the traveling direction pattern is the patterns (4) and (5), the subject vehicle Am easily recognizes the environment of the second intersection IS2 before entering the first intersection IS1. Therefore, before entering the first intersection IS1, the action determination section 63 may change a lane in advance to a lane where it is easy to turn at the second intersection IS2. At this time, the action determination section 63 may determine whether to change the lane in advance according to the length Lr of the connection road CR connecting the first intersection IS1 and the second intersection IS2. The action determination section 63 may change the lane in advance in a case where the traffic signal TS1 at the first intersection IS1 indicates a stop signal. The action determination section 63 may determine whether to change the lane in advance according to the congestion information of the connection road CR and the second intersection IS2.

As another embodiment, the plurality of consecutive intersections may be three or more consecutive intersections. The process by the mode setting section 76 can be applied by extending the first to fifteenth embodiments to three or more intersections without departing from the spirit of the mode setting.

As another embodiment, the vehicle control by the automated driving ECU 50b can be appropriately optimized according to the road traffic law, custom, and the like of each country and region. For example, in the first to fifteenth embodiment, left-hand traffic is premised, but the vehicle control can be optimized on the premise that the vehicle travels on the right side. In addition, in a case where a method of responding to a traffic signal, a method of executing a driving-mode switch, and the like are restricted by the road traffic law and the like, the vehicle control can be optimized according to the restriction.

As another embodiment, the intersections IS1 and IS2 referred to in the mode setting may be various intersections. For example, different mode settings may be made according to the driving control difficulty level for each traveling direction with respect to a complex intersection including a multi-way intersection such as a T-shaped intersection, a five-way intersection, or a six-way intersection, and a three-dimensional intersection, and a roundabout.

As another embodiment, the vehicle having the above-described vehicle system 1 is not limited to a general private passenger car, but may be a vehicle for a rental car, a vehicle for a manned taxi, a vehicle for ride-sharing, or the like.

In another embodiment, the process of S1621 to 1624, the process of S1805 to 1807, and the process of S2301 to S2307 are not limited to a situation in which a plurality of consecutive intersections includes the roundabout IS1R, IS2R, and may be applied to a situation in which one roundabout is passed.

In another embodiment, one roundabout may be regarded as a plurality of consecutive intersections by the environment recognition section 62 or the like as the situation identification section. This is because, in a case where the vehicle passes through one roundabout, a total of two turns occur in the right or left turn at the entrance ENT and the right or left turn at the exit PEX.

### OTHER TECHNICAL IDEA

The vehicle control device may be configured to be applied to the road traffic law in which a vehicle travels on the right, and configured such that a turn where planar intersection with an oncoming straight vehicle occurs corresponds to a left turn, and a turn where planar intersection with an oncoming straight vehicle does not occur corresponds to a right turn.

### OTHER TECHNICAL IDEA

A vehicle control method, of autonomously controlling driving of a subject vehicle, executed by at least one processor, the vehicle control method includes: identifying a situation of the subject vehicle; and making a determination regarding driving. The identifying the situation includes a identifying a situation in which the subject vehicle passes through a plurality of consecutive intersections when the subject vehicle is caused to travel along a scheduled route. The making the determination includes making a mode set in driving control a different setting according to a driving control difficulty level for a traveling direction in a case where the subject vehicle passes through the plurality of consecutive intersections.

What is claimed is:

1. A vehicle control device configured to execute autonomous driving control of a subject vehicle, the vehicle control device comprising
at least one of (i) a circuit and (ii) a processor with a memory storing computer program code executable by the processor, the at least one of the circuit and the processor configured to cause the vehicle control device to implement:
a situation identification section configured to identify a situation of the subject vehicle; and
a determination section configured to make a determination related to driving,
wherein
the situation identification section identifies a situation in which the subject vehicle passes through a plurality of consecutive intersections when the subject vehicle is caused to travel along a scheduled route,
the determination section sets a mode to be set in driving control differently according to a driving control difficulty level for passing through the plurality of consecutive intersections, and
the driving control difficulty level is a driving control difficulty level according to a direction of travel.

2. The vehicle control device according to claim 1, wherein
the determination section is configured to set a mode related to an automation level differently according to the driving control difficulty level.

3. The vehicle control device according to claim 2, wherein
in a case where the mode related to the automation level is switched to a mode for causing a driver to execute a manual driving,
the determination section decides to make a notification of starting the manual driving to the driver.

4. The vehicle control device according to claim 2, wherein
the plurality of consecutive intersections is two consecutive intersections,
in a case where the subject vehicle is scheduled to make a turn in which planar intersection with an oncoming straight vehicle does not occur at a first intersection and is scheduled to make a turn in which planar intersection with an oncoming straight vehicle does not occur at a second intersection, or in a case where the subject vehicle is scheduled to make a turn in which planar intersection with an oncoming straight vehicle occurs at the first intersection and is scheduled to make a turn in which planar intersection with an oncoming straight vehicle does not occur at the second intersection,
the determination section sets a mode for executing autonomous driving control, and
in a case where the subject vehicle is scheduled to make a turn in which planar intersection with an oncoming straight vehicle does not occur at the first intersection and is scheduled to make a turn in which planar intersection with an oncoming straight vehicle occurs at the second intersection, or in a case where the subject vehicle is scheduled to make a turn in which planar intersection with an oncoming straight vehicle occurs at the first intersection and is scheduled to make a turn in which planar intersection with an oncoming straight vehicle occurs at the second intersection,
the determination section sets a mode for causing a driver to execute manual driving.

5. The vehicle control device according to claim 2, wherein
the plurality of consecutive intersections is two consecutive intersections, and
in a case where the subject vehicle is scheduled to make a turn in which planar intersection with an oncoming straight vehicle does not occur at a first intersection and is scheduled to make a turn in which planar intersection with an oncoming straight vehicle does not occur at a second intersection,
the determination section sets a mode for causing a driver to execute manual driving in a case where there is a possibility that a vulnerable road user crosses a route on which the subject vehicle is scheduled to travel at the two consecutive intersections, and sets a mode for executing autonomous driving control in a case where there is no possibility.

6. The vehicle control device according to claim 2, wherein
the plurality of consecutive intersections is two consecutive intersections, and
in a case where the subject vehicle is scheduled to make a turn in which planar intersection with an oncoming straight vehicle does not occur at a first intersection and is scheduled to make a turn in which planar intersection with an oncoming straight vehicle occurs at a second intersection,
the determination section sets a mode related to the automation level to a mode for executing autonomous driving control when the subject vehicle passes through the first intersection, and to a mode for causing a driver to execute manual driving when the subject vehicle passes through the second intersection.

7. The vehicle control device according to claim 1, wherein
in a case where the subject vehicle is scheduled to make a turn at a first intersection among the plurality of consecutive intersections,
the determination section sets a speed limit such that a speed at which the subject vehicle travels at a second or subsequent intersection is lower than a speed at which the subject vehicle travels at the first intersection.

8. The vehicle control device according to claim 7, wherein
the determination section sets, on a road before the subject vehicle enters a second intersection, a speed limit that is lower than a speed at which the subject vehicle travels at the first intersection.

9. The vehicle control device according to claim 7, wherein
the determination section further decides to temporarily stop the subject vehicle, under the speed limit, after the subject vehicle has turned at the first intersection.

10. The vehicle control device according to claim 9, wherein
a temporary stop is released in a case where it is confirmed that the subject vehicle has recognized an environment of a next intersection.

11. The vehicle control device according to claim 9, wherein
in a case where it is not confirmed that the subject vehicle has recognized an environment of a next intersection within a preset threshold time during the temporary stop,
the determination section sets a mode for causing a driver to execute manual driving.

12. The vehicle control device according to claim 8, wherein
in a case where the subject vehicle approaches a next intersection under the speed limit without being confirmed that the subject vehicle has recognized an environment of the next intersection after the subject vehicle has turned at the first intersection,
the determination section further decides to temporarily stop the subject vehicle.

13. The vehicle control device according to claim 8, wherein
in a case where presence of a following vehicle following the subject vehicle is confirmed after the subject vehicle has turned at the first intersection,
the determination section prohibits temporary stop of the subject vehicle.

14. The vehicle control device according to claim 1, wherein
the plurality of consecutive intersections is two consecutive intersections, and
the determination section sets a mode having a different deceleration limit according to a traveling direction at a second intersection.

15. The vehicle control device according to claim 14, wherein
the determination section is configured to restrict strong deceleration in a case of being scheduled to make a turn in which planar intersection with an oncoming straight vehicle occurs, compared with a case of being scheduled to make a turn in which planar intersection with an oncoming straight vehicle does not occur.

16. The vehicle control device according to claim 2, wherein
the plurality of consecutive intersections is two consecutive intersections, and
in a case where the subject vehicle is predicted to stop before entering a second intersection due to a traffic signal indicating a stop signal at the second intersection or traffic congestion,
the determination section sets a mode for executing autonomous driving control.

17. The vehicle control device according to claim 2, wherein
the plurality of consecutive intersections is two consecutive intersections, and
in a case where the subject vehicle is predicted to stop before entering a second intersection due to a traffic signal indicating a stop signal at the second intersection or traffic congestion,
the determination section sets a mode for causing a driver to execute manual driving.

18. The vehicle control device according to claim 2, wherein
the plurality of consecutive intersections is two consecutive intersections, and
in a case where the subject vehicle is scheduled to make a turn in which planar intersection with an oncoming straight vehicle occurs at a first intersection and is scheduled to make a turn in which planar intersection with an oncoming straight vehicle occurs at a second intersection, and
in a case where the subject vehicle is predicted to stop before entering the second intersection due to a traffic signal indicating a stop signal at the second intersection or traffic congestion,
the determination section sets a mode for causing a driver to execute manual driving after the subject vehicle actually stops.

19. A non-transitory computer readable storage medium storing a vehicle control program for autonomously controlling driving of a subject vehicle, the vehicle control program for causing at least one processing section to execute:
identifying a situation of the subject vehicle; and
making a determination regarding driving,
wherein
the identifying the situation includes a identifying a situation in which the subject vehicle passes through a plurality of consecutive intersections when the subject vehicle is caused to travel along a scheduled route,
the making the determination includes making a mode set in driving control a different setting according to a driving control difficulty level in a case where the subject vehicle passes through the plurality of consecutive intersection, and
the driving control difficulty level is a driving control difficulty level according to a direction of travel.

20. A vehicle control method, of autonomously controlling driving of a subject vehicle, executed by at least one processing section, the vehicle control method comprising:
identifying a situation of the subject vehicle, and
making a determination regarding driving,
wherein
the identifying the situation includes a identifying a situation in which the subject vehicle passes through a plurality of consecutive intersections when the subject vehicle is caused to travel along a scheduled route,
the making the determination includes making a mode set in driving control a different setting according to a driving control difficulty level in a case where the subject vehicle passes through the plurality of consecutive intersections, and
the driving control difficulty level is a driving control difficulty level according to a direction of travel.
